(19) United States
(12) Patent Application Publication
(10) Pub. No.: US 2003/0193491 A1
(43) Pub. Date: Oct. 16, 2003

(54) Method of and apparatus for driving a display device

(75) Inventors: Nicholas A. Lawrence, Cambridge (GB); Timothy D. Wilkinson, Cambridge (GB); William A. Crossland, Harlow (GB)

Correspondence Address: PILLSBURY WINTHROP, LLP, P.O. BOX 10500, MCLEAN, VA, 22102, US

(73) Assignee: CAMBRIDGE UNIVERSITY TECHNICAL SERVICES LIMITED, Cambridge (GB)

(21) Appl. No.: 10/412,273

(22) Filed: Apr. 14, 2003

Related U.S. Application Data
(60) Provisional application No. 60/372,088, filed on Apr. 15, 2002.

(51) Int. Cl. G09G 5/00

(52) U.S. Cl. 345/204

(57) ABSTRACT

A display device has a number of pixels to display an image. A first set of electrodes and a second set of electrodes are provided. To display an image in accordance with image data, the first and second sets of electrodes are addressed with a first set of drive signals and a second set of drive signals respectively in order to drive the pixels of the display device. The first set of drive signals is predefined. The image data is compressed. The second set of drive signals is obtained from the compressed image data.

The present application claims priority to U.S. Provisional Application Nos. 60/372,088, filed on Apr. 15, 2002, the entire contents of which are incorporated herein by reference.

### BACKGROUND

1. Field of Invention

The present invention relates to a method of and apparatus for driving a display device.

2. Discussion of Related Art

When “addressing” a display device, such as liquid crystal display panel, to display an image, i.e. when providing the drive signals to the pixels of the display device, it is conventional to provide a set of first drive signals (e.g. the row drive signals) and a set of second drive signals (e.g. the column drive signals) to the electrodes that surround each pixel. The row drive signals are typically predefined and are typically in the form of a matrix, herein referred to as a row matrix. On the other hand, the column drive signals, which again are typically in the form of a matrix herein referred to as a column matrix, must be calculated. Typically, the image data is compressed in order to reduce the file size of the image data prior to transmission from a source to the apparatus associated with the display device. Compression is particularly useful when the image data is to be transmitted over a network, especially a wireless network, and in any event in order to minimise storage requirements at the apparatus associated with the display device.

In most forms of image coding and compression, the first step in the process is to apply a two-dimensional transform to the raw image. The purpose of this is to rearrange the information content of the image so that it is concentrated into a small number of transform coefficients. This allows near-zero coefficients to be approximated to zero in order to achieve compression.

Conventionally, the compressed image data is received at the apparatus associated with the display device and is then decompressed to provide an image matrix. The column drive signals are then obtained by multiplying this image matrix by the transposed row matrix and optionally also by a scale factor. This means that potentially many multiplications and a summation are required to calculate each element in the column matrix. This means that apparatus associated with the display device has high computational, memory and power-consumption requirements. This in turn means that the circuitry for the apparatus associated with the display device is inevitable expensive and, in the case of portable apparatus, demanding on battery life.

### BRIEF DESCRIPTION OF THE INVENTION

According to a first aspect of the present invention, there is provided a method of driving a display device to display an image thereon in accordance with image data, the display device having a first set of electrodes and a second set of electrodes which are addressed with a first set of drive signals and a second set of drive signals respectively in order to drive pixels of the display device, the first set of drive signals being predefined, the image data being compressed, the method comprising: obtaining the second set of drive signals from the compressed image data; and, addressing the pixels of the display device with the first and second set of drive signals thereby to display an image corresponding to the image data on the display device.

The principal advantages of the preferred embodiment of the present invention are that there are reduced computational, memory and power-consumption overheads required of the circuitry of the display device when compressed image data is provided. This is because it is not necessary first to decompress the compressed image data and then obtain the second set of drive signals as in the prior art. This is particularly useful when displaying such compressed images on a mobile device, such as a mobile (“cell”) telephone, portable computer, so-called personal digital assistants (“PDAs”) and the like.

In an embodiment, the first set of drive signals is represented by a first matrix and the second set of drive signals is represented by a second matrix, and the obtaining of the second set of drive signals from the compressed image data comprises multiplying the compressed image data by the transpose of the first matrix thereby to obtain the second matrix.

The first matrix may be a discrete cosine transform (DCT) based row matrix.

Alternatively, the first matrix may be a discrete wavelet transform (DWT) based row matrix. The discrete wavelet transform (DWT) based row matrix may have LeGall 5,3 wavelet coefficients, in which case the obtaining of the second set of drive signals from the compressed image data preferably comprises multiplying the compressed image data by the transpose of the first matrix thereby to obtain an intermediate matrix and then normalising the intermediate matrix thereby to obtain the second matrix. This helps to improve the quality of the reproduced image in this embodiment.

Other alternatives for the form of the row matrix are discussed further herein.

In a preferred embodiment, the compressed image data is obtained by at least a 2-D transform of raw image data, the second set of drive signals being obtained from the transformed raw image data without carrying out a full inverse transform of the transformed raw image data. In other words, the second set of drive signals is obtained without access to the raw image data.

The display panel may be a liquid crystal display panel, the first set of drive signals being row drive signals and the second set of drive signals being column drive signals.

According to a second aspect of the present invention, there is provided apparatus for driving a display device to display an image thereon in accordance with image data, the display device having a first set of electrodes and a second set of electrodes which are addressed with a first set of drive signals and a second set of drive signals respectively in order to drive pixels of the display device, the first set of drive signals being predefined, the image data being compressed, the apparatus comprising: a drive signal calculating device constructed and arranged to obtain the second set of drive signals from the compressed image data; and, an addressing device constructed and arranged to address the pixels of the display device with the first and second set of drive signals thereby to display an image corresponding to the image data on the display device.

In an embodiment the first set of drive signals can be represented by a first matrix and the second set of drive signals can be represented by a second matrix, the drive signal calculating device being constructed and arranged to obtain the second set of drive signals from the compressed image data by multiplying the compressed image data by the transpose of the first matrix thereby to obtain the second matrix.

In a preferred embodiment the compressed image data is obtained by at least a 2-D transform of raw image data, the drive signal calculating device being constructed and arranged to obtain the second set of drive signals from the transformed raw image data without carrying out a full inverse transform of the transformed raw image data.

The display panel may be a liquid crystal display panel, the first set of drive signals being row drive signals and the second set of drive signals being column drive signals.

In a most preferred embodiment, the drive signal calculating device and the addressing device are constituted in a single integrated circuit.

According to another aspect of the present invention, there is provided the use of image compression matrices (of the type used in compression standards such as JPEG, JPEG2000, MPEG-1, MPEG-2 and MPEG-4) in the generation of addressing signals for addressing the pixels of a display device.

### BRIEF DESCRIPTION OF THE DRAWINGS

Embodiments of the present invention will now be described by way of example with reference to the accompanying drawings, in which:

FIG. 1 shows schematically prior art matrix addressing;

FIG. 2 shows schematically a graphical representation of how the column signal matrix is generated as a function of the original image matrix and the row matrix in the prior art;

FIG. 3 shows schematically how different grey levels can be represented in the prior art;

FIG. 4 shows schematically Grey level generation by the full-interval PHM method using a virtual row to introduce a correction signal in the prior art;

FIG. 5 shows schematically the split interval PHM greyscale method compared with the alternative PWM method in the prior art;

FIG. 6 shows schematically the interrelation between MLA (multiple line addressing) system parameters (shown in black) and the resulting characteristics of the display (shown in grey) in the prior art;

FIG. 7 shows a plot of selection ratio vs. scale factor for an image with 256 rows in the prior art;

FIG. 8 shows the standard ‘Lenna’ test-image on the left and, on the right, the result of using the full-interval greyscale method but omitting the correction signals;

FIG. 9 shows computed voltages across an arbitrary pixel in a 256×256 image of ‘Lenna’ for different addressing schemes;

FIG. 10 shows a plot of maximum pixel voltage against the number of simultaneously selected rows L;

FIG. 11 shows schematically a comparison between a conventional method (labelled A) and an example of a method in accordance with an embodiment of the present invention (labelled B) for generating column drivers;

FIG. 12 shows schematically the logical architecture of system for generating column drivers from both remote and local image data;

FIG. 13 shows a MLA row matrix based on the 8×8 DCT function;

FIG. 14 shows an image produced in a simulation of an example of a method in accordance with an embodiment of the present invention in which a DCT-based row matrix and an adapted form of the full-interval greyscale method were used;

FIG. 15 shows the structure of an example of a three-scale, eight-element DWT matrix;

FIG. 16 shows an extension of a data sequence for use in a DWT matrix;

FIG. 17 shows the results of a simulation using a MLA row matrix based on a Haar wavelet in a three-scale decomposition;

FIG. 18 shows on the left hand side the perfect monochrome image obtained from the Haar wavelet-based simulation and on the right hand side the result of a simulation using the Daubechies wavelet-based row matrix;

FIG. 19 shows a plot of vector magnitude across the rows of the Daubechies wavelet row matrix;

FIG. 20 shows the image produced by the simulation of a MLA system using a Daubechies wavelet-based row matrix in which the column matrix is normalised;

FIG. 21 shows the results of MLA simulations using row matrices based on the LeGall 5,3 wavelet, the image on the left being produced using the standard DWT matrix and the image on the right being produced by normalising the row matrix before it was used;

FIG. 22 shows a comparison of close-up portions of the target image (shown left) and the simulated image (shown right) using a normalised row matrix based on the LeGall 5,3 wavelet; and,

FIG. 23 shows close up views of the images produced by simulations using the Daubechies 9,7 wavelet (shown left) and the ‘Near-Symmetric’ 5,7 wavelet (shown right).

### DETAILED DESCRIPTION OF THE PREFERRED EMBODIMENT

There will first be given a description of multiple line addressing as applied to passive matrix displays. There will then be given a description of an example of a new architecture for displays receiving compressed image data in accordance with an embodiment of the present invention, this description including a discussion of image compression techniques. Whilst the description is principally given in the context of passive matrix display devices, the principles of the present invention may also be applied to active matrix display devices.

Multiple Line Addressing (MLA)

Background

By the late 1980s and early 1990s, laptop computers were becoming widely available and achieving significant commercial success. Most early laptops used a passive matrix LCD screen and achieved an acceptable VGA resolution by means of a dual-scan architecture. The 1990s saw a huge growth in the amount of computer software used for graphical and video applications and this caused a problem for the dual-scan passive matrix technology. Dual-scan laptop computer screens were well known for their smearing of fast-moving objects such as the mouse pointer. The reason for the smearing was the slow response of the LC material itself to changes in addressing voltages. The long response time was a deliberate choice by manufacturers to ensure that the rms-responding behaviour occurred and that Alt and Pleshko's rule could be applied. A typical response time for a standard passive-matrix LCD would be in the region of 200 to 300 ms, which obviously is incompatible with video frame rates of 30 fps and higher.^{[1]} To develop screens capable of displaying video images, new LC materials were tried with lower viscosities. These had faster response times of the order of 150 ms, which was estimated to give much better visual performance for video. However, it was discovered that these materials produced very poor quality images since the large ‘row-select’ pulses became discernible as flickers on the screen. This phenomenon became known as ‘frame-response’ and was a major problem. It occurred because the response time of the LC was no longer large enough, compared to the duration of the addressing pulses, to ensure the validity of the rms response conditions. Therefore, the LC was responding to the large magnitude selection signals within each frame.

To overcome the problem of frame response, the idea of selecting several rows at a time was investigated. Nehring and Kmetz had proved that any number of different row-functions could achieve the optimal selection ratio, for a given number of rows, as long as certain conditions were met.^{[2]} One of these conditions is that all row-functions need to have the same rms value, averaged over a frame period. From a purely intuitive point of view it is possible to see that the same rms frame voltage could be obtained using one large pulse or several smaller pulses. Since it is the large magnitude of the single pulse that causes the frame response problem, using several small pulses should improve performance. This is the basic idea behind multiple line addressing (MLA).

Principle of Operation

The mathematical analysis outlined here is based on the work of several pioneers of MLA research such as Alt and Pleshko^{[3]}, Kmetz and Nehring^{[2]} and Scheffer^{[4]}. Consider a liquid crystal matrix of N rows and M columns. Let an information matrix, A, represent the desired information to be displayed on the matrix, with element Aᵢⱼ corresponding to the pixel at the intersection of row i and column j. Initially, the pixel states are restricted to one of two values, defined as Aᵢⱼ=−1 for a selected or ‘on’ pixel and Aᵢⱼ=+1 for a non-selected or ‘off’ pixel. Let each matrix row, i, be driven with a row signal Fᵢ(t) that is periodic over the frame period, T, and each column, j, be driven by a periodic column signal Gⱼ(t). The voltage across a pixel, Uᵢⱼ(t), is given by the difference between the row and column signals:

Uᵢⱼ(t)=Fᵢ(t)−Gⱼ(t) (1)

These definitions for matrix addressing are illustrated in FIG. 1. Each element of the column voltage signal, Gj(t), is calculated from the dot-product of one row of the row-voltage matrix, F, with one column of the information-matrix, A. This is the rule defined by Nehring and Kmetz in their 1979 paper^{[2]}.

The rms average of the pixel voltage over a frame period is defined as:

$$< {U}_{ij} >= \frac{1}{\sqrt{T}} \sqrt{{\int }_{0}^{T} {{U}_{ij} ( t )}^{2} ⅆ t} \qquad ( 2 )$$

Substituting Equation (1) into (2) gives the following expression:

$$< {U}_{ij} >= \frac{1}{\sqrt{T}} \sqrt{{\int }_{0}^{T} {{F}_{i} ( t )}^{2} ⅆ t - 2 {\int }_{0}^{T} {F}_{i} ( t ) {G}_{j} ( t ) ⅆ t + {\int }_{0}^{T} {{G}_{j} ( t )}^{2} ⅆ t} \qquad ( 3 )$$

It is a requirement from Nehring and Kmetz's paper that the row signals, Fᵢ(t), are orthonormal and so the product of two row signals will always be zero except for the case when a row is multiplied by itself, i.e.

$$\frac{1}{\sqrt{T}} = \sqrt{{\int }_{0}^{T} {F}_{j} ( t ) {F}_{k} ( t ) ⅆ t} = \{ \begin{matrix}F ( j = k ) \\ 0 ( j \neq k )\end{matrix} \qquad ( 4 )$$

Nehring and Kmetz require that the column signal is proportional to the dot product of the information vector and all of the row signals at time t, hence:

$${G}_{j} ( t ) = c {\sum }_{i = 1}^{N} {A}_{i j} {F}_{i} ( t ) \qquad ( 5 )$$

where c is a constant of proportionality that can be set later to satisfy Alt and Pleshko's optimum selection ratio criterion. Using Equations (4) and (5), the expression in Equation (3) simplifies to:

<Uᵢⱼ>=F\sqrt{1−2cAᵢⱼ+Nc²} (6)

The importance of this result is that the rms voltage across pixel (i,j) depends only on the corresponding information element for that pixel. This fact is critical because it means the state of one pixel does not affect the states of other pixels. Another way of expressing this would be to say that there is no ‘static cross-talk’.

Calculation of Column Voltage Signals

In Equation (5) the column signal is described in terms of a dot-product calculation between vectors from the row and information matrices. Equation (5) defines a single column of the column matrix in this way, but the implication of this is that a more compact matrix representation may be used to describe the whole column matrix. The entire column matrix G can be calculated as a scaled matrix multiplication of the transposed row matrix F^{T} and the information matrix A as follows.

G=cF^{T}A (7)

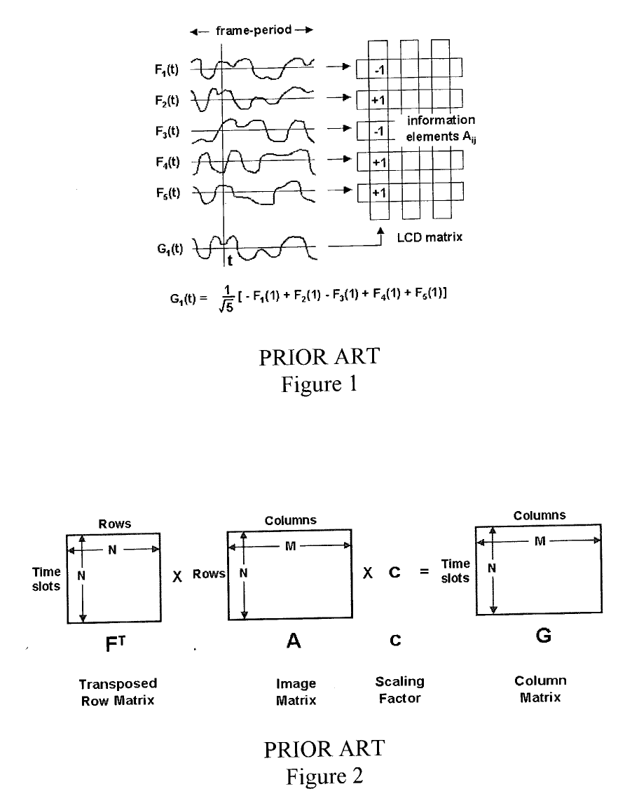

This is not immediately obvious, but it can be verified by careful examination of Equation (5) and has been rigorously proved by Nehring and Kmetz. It can be shown that even the normal ‘line-at-a-time’ addressing method is a special case of this rule. FIG. 2 illustrates this point by showing the relationship between the row matrix, F, the information matrix, A, and the column matrix, G. FIG. 2 shows a graphical representation of how the column signal matrix is generated as a function of the original image matrix and the row matrix. The scaling factor c affects the selection ratio of the final image matrix and must be optimised as a function of M.

Matrix multiplication calculates each element in the final matrix as the dot-product of a row of the first matrix with a column of the second matrix. For example, the top-left element of the final matrix is calculated from the dot-product of the first row of the transposed row-matrix with the first column of the information matrix. This means that potentially, many multiplications and a summation are required to calculate each element in the column matrix. However, the situation improves if any of the elements in a row of the row matrix are zero, since these parts of the dot product do not need to be calculated. The issue of calculation complexity is discussed in greater detail below as part of a wider look at optimising MLA schemes.

Greyscale Generation for MLA

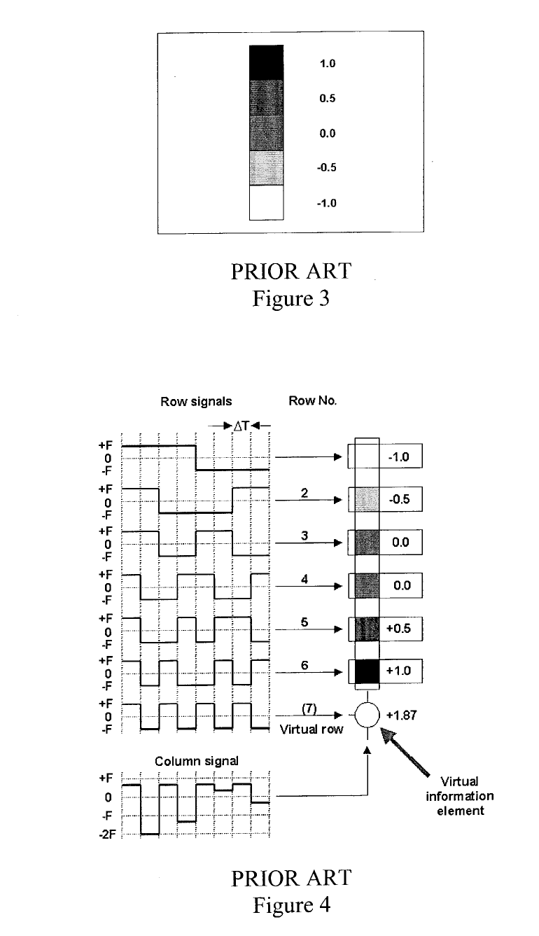

The FRC (frame-rate control) method can in fact be used for MLA systems without any changes but only a limited number of grey shades will be possible due to frequency limitations. However, in order to use the other methods in a MLA environment, it is necessary to make some modifications. The reason for this is demonstrated using an extension of the mathematical analysis given above. Grey-scale values are represented in the information matrix, A, as elements whose value may lie anywhere on the continuum between −1 and +1. FIG. 3 illustrates how different grey levels are represented according to this system. In particular, FIG. 3 shows an illustration of how intermediate grey levels are represented using the notation of the mathematical analysis above. A zero value represents a mid-grey shade.

Using this new definition for the values that Aᵢⱼ may take, Equation (6) changes to:

$$< {U}_{ij} >= F \sqrt{1 - 2 c {A}_{i j} + {c}^{2} {\sum }_{m = 1}^{N} {A}_{m j}^{2}} \qquad ( 8 )$$

In this case, the summation term means that the pixel voltage is no longer dependent solely on the state of the corresponding element of the information matrix, but also on all other elements in the same column. Therefore, static cross-talk has been introduced, which will degrade the image. This problematic summation term is the main challenge facing designers of grey-scale algorithms for MLA displays. Two different solutions will now be described, which are both based on Conner and Scheffer's pulse-height modulation (PHM) ideas^{[5]}.

Full-Interval PHM

This technique addresses the problem of the summation term directly and maintains the correct rms pixel voltage averaged over a frame-period. The underlying aim of the technique is to replace the summation term by a constant term and this is achieved through the introduction of a ‘virtual-row’. Consider a display with N+1 rows. Let the information element for the (N+1)th row and the jth column, which will be called the ‘virtual information element’, be designated as V_{(N+1)j}. If this term is included into Equation (8) it becomes:

$$< {U}_{ij} >= F \sqrt{1 - 2 c {A}_{i j} + {c}^{2} {\sum }_{m = 1}^{N} {A}_{m j}^{2} + \frac{1}{N} {V}_{( N + 1 ) j}^{2}} \qquad ( 9 )$$

If the virtual information element is constrained to fulfil the following condition:

$${V}_{( N + 1 ) j} = \sqrt{N - {\sum }_{m = 1}^{N} {A}_{m j}^{2}} \qquad ( 10 )$$

then Equation (9) simplifies to:

$$< {U}_{ij} >= \sqrt{2} F \sqrt{1 - \frac{1}{\sqrt{N}} {A}_{i j}} \qquad ( 11 )$$

This is the desired result because the pixel voltage is once again solely dependent on the information element, Aᵢⱼ. In practice, a column voltage signal is still calculated as the dot product of a row vector and column of the information matrix. However, these vectors are now each of length N+1 rather than N. FIG. 4 shows the (N+1)th row added and the calculation of the correction-signal for the virtual information element, which ensures that no static cross-talk occurs.

Equation (10) describes the calculation of the required correction pulse. It involves the values of all elements in a column of the information matrix and can take any magnitude between 0 and \sqrt{N}. Since N is the number of rows in the display, the magnitude of the correction pulse can be very large compared to the rest of the column signal. This is a problem since it requires more expensive voltage drivers with a higher drive-voltage capability. If large values of L are used, as in the case of ‘active-addressing’, then the magnitude of the correction pulse can be controlled in the following way. By changing the polarity of some of the row signals and carefully choosing their order, the probability of the correction pulse exceeding a certain threshold value can be dramatically reduced. As a consequence, if the column voltage is limited to this threshold value, good quality pictures will still be produced since only one correction pulse in many thousands is being suppressed. [4] Changing the order and polarity of some of the row signals also affects the cross-talk performance of the display. A very good computer simulation of how the row function affects cross-talk and suppression of frame-response was presented by Kawaji et al. at SID 96.^{[6]}

Split-Interval PHM

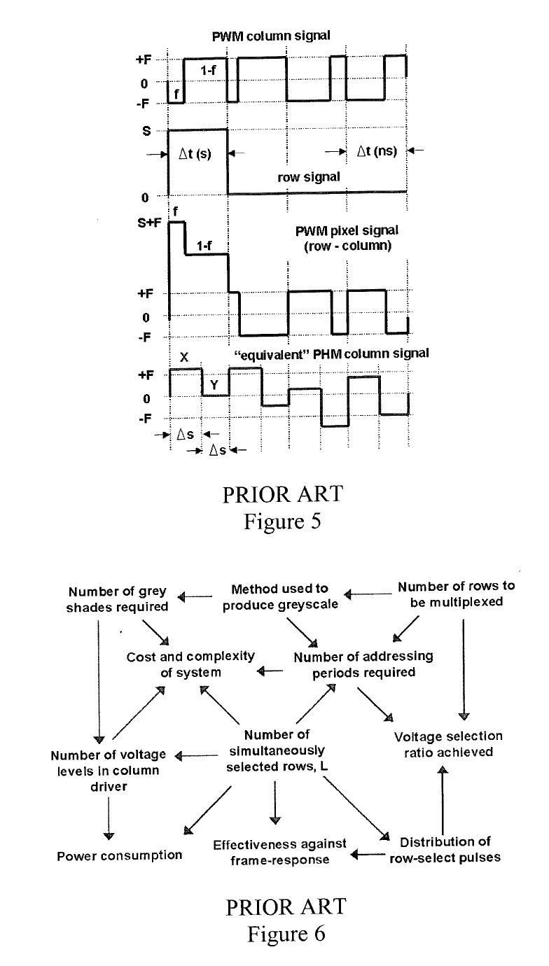

In contrast to the full-interval method, split-interval PHM ensures the correct rms average pixel voltages over each ‘row-select period’ rather than over a frame period. It is actually very similar in principle to PWM and can be derived by reference to that method. For a grey level corresponding to a certain fraction ‘f’ of an ‘on’-pixel, the column voltage is held at −F for the same fraction f and at +F for the remaining fraction (1-f) of a row-select period Δt. This is shown in FIG. 5 together with the split-interval PHM implementation. In FIG. 5, the split interval PHM greyscale method is compared with the alternative PWM method. Note that the PHM scheme uses fixed length pulses of Δs and so is less prone to the high frequency roll-off effects that cause problems for the PWM scheme.

Since in this case the row-select pulse is positive, a column voltage of −F gives a large voltage difference across the pixel, whilst +F at the column signal gives a small voltage across the pixel. Therefore, the larger the fraction, f, the longer that −F is applied to the column and the more the pixel is turned on. The rms pixel voltage in one select time interval, Δt(s), is given by:

<U_{Δt(s)}>=\sqrt{f(S+F)²+(1−f)(S−F)²} (12)

Similarly, in a non-select time period the rms pixel voltage is given by:

<U_{Δt(ns)}>=F (13)

In the split-interval PHM case, the same rms pixel values can be expressed in terms of the amplitude levels X and Y:

$$< {U}_{Δ t ( s )} >= \sqrt{\frac{1}{2} {( S - X )}^{2} + \frac{1}{2} {( S - Y )}^{2}} \qquad ( 14 )$$

By equating (12) and (14) we see that:

X²+Y²=2F² (15)

For dc balancing, we require the two schemes to produce the same mean pixel voltage as well as the same rms pixel voltage, so:

$$\frac{1}{2} ( X + Y ) = - F f + F ( 1 - f ) \qquad ( 16 )$$

Equations (15) and (16) can then be combined to derive expressions for X and Y in terms of the grey-scale fraction, f:

X=F(1−2f+2{square root over (f(1−f)))}

Y=F(1−2f−2{square root over (f(1−f)))} (17)

To implement this scheme for a large number of possible grey levels, it would be necessary store a look-up table in ROM. This would allow the correct values for X and Y to be used for a given f value. This is perhaps a disadvantage with this scheme, as is the double-frequency column signal that is required. Nevertheless, an advantage of the spilt interval scheme over the full interval method is that no correction pulse is required.

Optimisation of MLA Parameters

The Aims of Optimisation

There is considerable flexibility available to the designer of a MLA drive scheme to decide which aspects of the system to optimise. The four main characteristics of a MLA system that should be considered in an optimisation are:

Frame Response—The main reason behind the invention of MLA techniques in the first place was the suppression of the flicker effects known as ‘frame-response’. Therefore, the primary objective of all MLA schemes should be effectiveness in combating this problem.

Selection Ratio—Any orthonormal row matrix can lead to the optimal Alt and Pleshko selection ratio value. However, there may be reasons why a non-orthonormal row matrix could be advantageous and in those cases the selection ratio will need to be maximised.

Complexity and Cost—The main strength of passive matrix LCDs compared to their active matrix counterparts is lower cost. The two main sources of potential cost increases in a MLA drive scheme are the driver ICs and the circuitry needed to calculate the column signals. The cost of a driver IC is related to the number of different voltage levels that it must be able to produce and its maximum voltage rating. The complexity and cost of the circuitry for calculating the column signals depends on the arithmetic operations and the amount of memory required.

Power Consumption—Most applications of passive matrix LCDs are in battery-driven products, so power consumption is a very important consideration. Battery life of a mobile product is one of the key selling points and MLA offers the opportunity of significant power savings compared to the standard ‘Improved Alt and Pleshko’ (IAPT) method.^{[7]} Power consumption is a function of the supply voltage and the drive frequency, both of which may be affected by the choice of certain MLA parameters.

The Inter-Relationship Between Parameters

There are several different parameters in a MLA system that can be varied and their effects are often inter-related. The most important parameters are outlined below together with their impact on the system as a whole. FIG. 6 demonstrates the inter-relation between the various parameters, giving an indication of the complicated nature of the optimisation process. MLA system parameters are shown in black and the resulting characteristics of the display are shown in grey.

The Number of Voltage Levels in the Row Matrix

The number of different voltage levels in the row matrix has two effects on the complexity and cost of a MLA system. Firstly, the more voltage levels required from the row drivers, the more complicated they need to be, leading to a corresponding rise in cost. Secondly, as the number of voltage levels in the row matrix increases so does the number of different voltage levels required in the column drivers. This follows from Equation (5) since the column signals are calculated as dot products of vectors from the row and information matrices. Most row matrices used in MLA systems are either bi or tri-level functions for these reasons. However, if there were a compelling reason for using a more complicated row matrix, then it would be quite valid to do so from a performance point of view.

Orthonormality of the Row Matrix

Nehring and Kmetz proved that an orthonormal row matrix was a necessary condition in order to achieve the optimum Alt and Pleshko voltage selection ratio. However, this does not necessarily mean that non-orthonormal matrices should be ignored altogether. It has been proven by Ruckmongathan^{[8]} that non-orthonormal row matrices can be used to address images without causing any static crosstalk or artefacts. Moving away from orthonormality leads to a reduction in selection ratio from the optimum value but it need not be by too much. Another consequence of using a row matrix that is not orthogonal is that Equation (7) has to be modified to:

G=cF⁻¹A (18)

The difference here is that the column matrix is calculated from the inverse of the row matrix rather than the transpose. If the row matrix is orthonormal then the transpose equals the inverse and Equation (18) reverts to the familiar Equation (7). The constant c in Equation (18) is called the scaling factor and this must be set to an optimum value in order to maximise the voltage selection ratio.

Scaling and Normalisation

Alt and Pleshko showed that when an orthonormal row matrix is used, the selection ratio can be maximised when the scale factor is set to an optimum value that is a function of the number of rows, N. Equation (19) gives the optimum scale factor value.

$$c {\vert}_{OPT} = \frac{1}{\sqrt{N}} \qquad ( 19 )$$

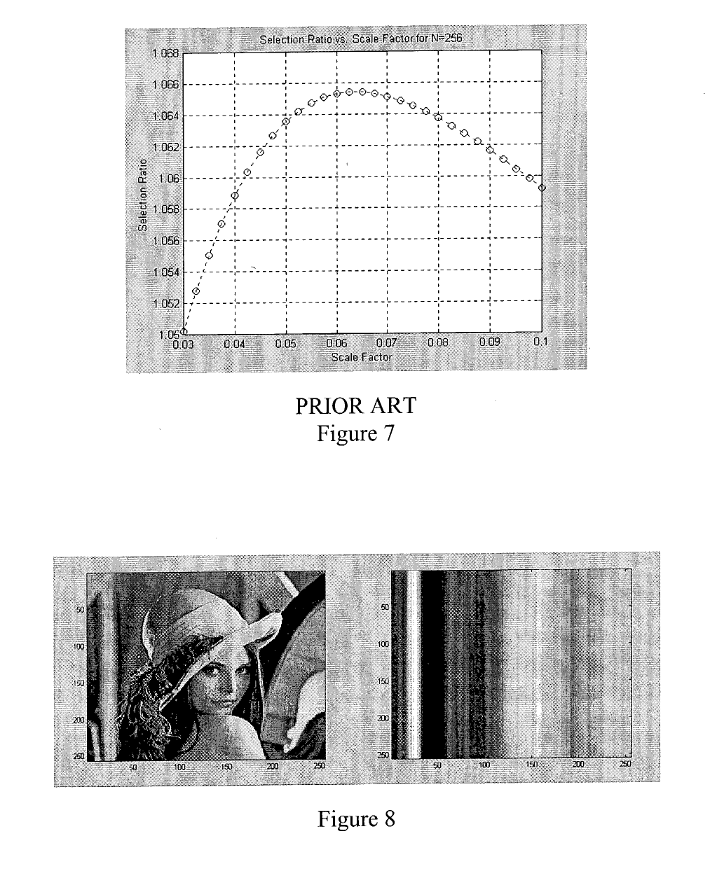

If the scale factor deviates from the optimum value, the selection ratio drops as shown in FIG. 7. The equation for the selection ratio as a factor of c is given by Equation (20) as follows:

$$sel\_ratio = \sqrt{\frac{{( \frac{1}{c} + 1 )}^{2} + N - 1}{{( \frac{1}{c} - 1 )}^{2} + N - 1}} \qquad ( 20 )$$

It is this equation that is plotted in FIG. 7, which shows a plot of selection ratio vs. scale factor for an image with 256 rows. The maximum selection ratio of 1.065 matches the optimum Alt and Pleshko value and it occurs when c=0.0625 as predicted by Equation (19). Equation (19) can be derived from Equation (20) by differentiating and setting to zero.

It is interesting to see what happens when either the row or the column matrix is not normalised. The correction signal used in the ‘full-interval’ greyscale method shown above is required to ensure that the columns in the column matrix are normalised. If the correction signal is omitted, the vector magnitude of each individual column depends on the image information present in that column and so can vary greatly between columns. This causes a very severe vertical striping effect to be seen, as shown in the right half of FIG. 8, where the image information is totally lost. The amount of distortion is directly proportional to the variation in the number of intermediate grey levels present in each column. Fully on pixels are represented by −1 values and fully off pixels by +1, but intermediate grey levels lie in the range between. The image shown in the left-hand side of FIG. 8 is the standard Lenna image, as seen in previous figures, which has a very high variation of this type. The image on the right is the result of using the full-interval greyscale method but omitting the correction signals. The massive amount of vertical stripe distortion is the result of the large variations in vector magnitude between different columns. The vector magnitude depends on the number of intermediate grey levels present in the column.

If the rows of the row matrix are not normalised then this also leads to some artefacts being visible on the resulting image. In this case, the artefacts take the form of horizontal stripes. The severity of the artefacts depends on the variation in vector magnitude between the different rows in the row matrix.

The Number of Simultaneously Selected Rows

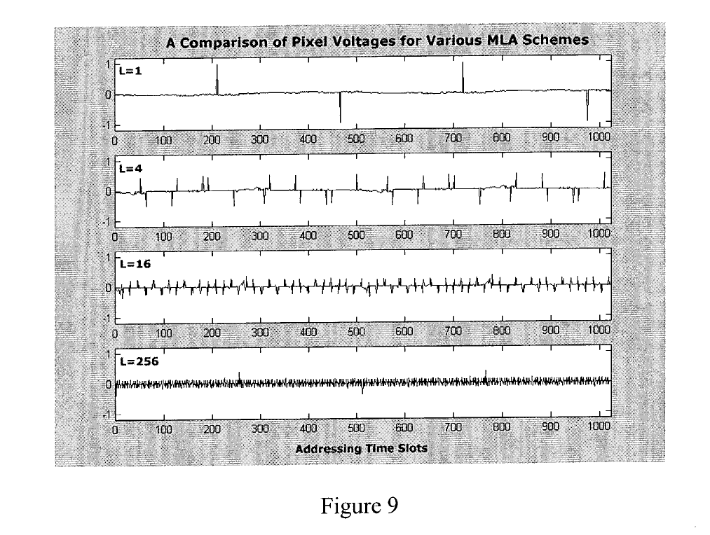

As FIG. 8 shows, the value of L, the number of simultaneously selected rows, has an effect on most aspects of a MLA system. Nehring and Kmetz's fundamental paper in 1979 demonstrated how Alt and Pleshko's selection ratio rule was indeed optimal and could be achieved using any orthonormal row matrix. As a result, most MLA research has been based on investigating the effectiveness of various orthonormal matrices as row functions. Perhaps the most crucial question regarding the value of L is regarding its effect on the reduction of frame response. Is there an optimal value of L for a given display dimension, N, that minimises frame response? Frame response occurs when the liquid crystal responds to large instantaneous voltage changes rather than the rms average. Therefore, it follows that the problem would be alleviated by reducing the maximum magnitude of the voltage transitions across the liquid crystal. As more lines are selected simultaneously, the magnitude of each selection pulse reduces, whilst still maintaining the same rms average over a frame period. This would suggest that the optimum approach would be to use a row matrix that selects all the rows simultaneously. The row matrix based on Walsh-Hadamard matrices, as used by Scheffer et al., is an example of this approach. However, when various different MLA algorithms were assessed for their ability to reduce frame-response, Scheffer's ‘active-addressing’ method performed worse than other simpler algorithms.^{[9]} The reason why this should be the case comes from considering exactly what the voltages across the LCD will be for various schemes. The optical performance of the liquid crystal is dependent not simply on the row voltages but on the difference between the row and column voltages. FIG. 9 shows the computed voltage across an arbitrarily chosen pixel in a 256×256 image of ‘Lenna’ for a range of different addressing schemes. The single line at a time (LAAT) method is contrasted against MLA schemes where the number of simultaneously selected rows L is set at 4, 16 and 256 respectively.

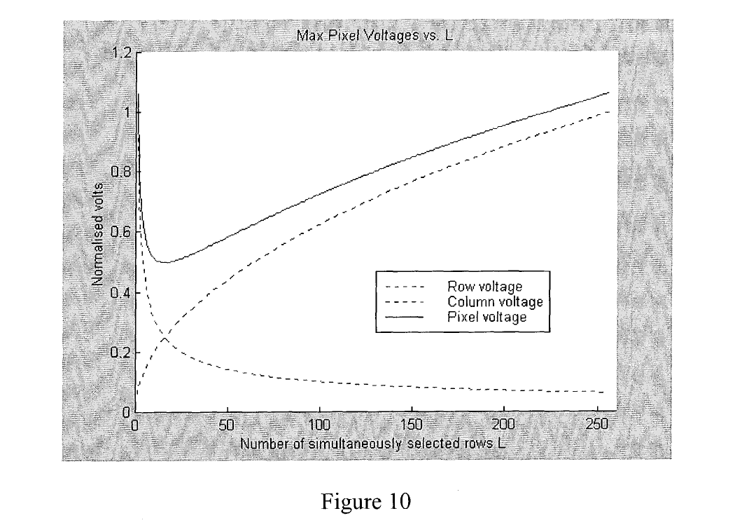

FIG. 9 is plotted for an arbitrarily chosen pixel from an image of a face. The maximum size of the voltage across a given pixel is strongly dependent on the content of the whole image. This dependence becomes stronger as L increases. The problem of frame response is exacerbated if the pixel voltage signal contains large instantaneous peak values. Therefore a useful metric of frame response suppression is a plot of maximum pixel voltage magnitude vs. L as shown in FIG. 10. The maximum pixel voltage is defined as the sum of the maximum row voltage and the maximum column voltage although this could be a signal of either polarity depending on the image data. The pixel voltage is minimised when L=16 in this case. In general, it is minimised when L=\sqrt{N} where N is the number of rows being multiplexed. Note that as L increases, so the maximum size of the row voltage pulses reduces. In contrast, the maximum size of the column voltage pulses increases with L. Therefore, the pixel voltage, being the difference between the row and column voltages, is minimised for an intermediate value of L. In FIG. 9 the plot for L=16 actually shows a lower peak voltage than the L=256 case. This is consistent with a stronger reduction in frame response for the L=16 case than the L=256 case.

It is clear that the choice of L has a significant effect on the suppression of frame response. The result shown in FIG. 10 regarding the pixel voltage being minimised for a value of L=\sqrt{N} has not been explicitly published before, although Kuijk, Henzen and Smid published a paper in 1999 proving that the supply voltage needed for a MLA system, and hence the power consumption, is minimised when L=\sqrt{N}.^{[10]} The observation about the pixel voltage being minimised is simply a new interpretation of this result, although it is important because it suggests that frame response is minimised and it provides a further reason to think that setting L=\sqrt{N} results in an optimal system performance.

The value chosen for L is also critical in determining the complexity and cost of a MLA system. The memory requirement and the number of different column voltage levels needed both increase linearly with L. In fact for binary pixel values the number of voltage levels N_{V} required in a MLA drive scheme is a simple function of the number of simultaneously selected rows, L, as shown here:

N_{V}=L+1 (21)

In a scheme where two rows are selected simultaneously (i.e. L=2), each row of the row-matrix will have two non-zero elements. Therefore, two multiplications and one summation will be required to calculate each element of the column matrix. Similarly, when L=4, each element in the column matrix is calculated from four multiplications and a summation. The extreme case for MLA is when all of the rows are selected simultaneously. This is indeed the method used by Scheffer et al. in the ‘Active-Addressing’ scheme.^{[4]} When all rows are selected simultaneously, all elements in the row matrix are non-zero and therefore full-sized vector dot-products are required to calculate each column matrix element. The active addressing scheme requires TFT-style column driver ICs to be used since they can provide voltage levels across a continuous range rather than the few discrete levels provided by standard passive matrix column drivers. This adds significantly to the cost of the system.

The relationship given in Equation (21) relating the number of column voltage levels, N_{V}, and the number of simultaneously selected rows, L, is only valid for bi-level pixel values. Once the required number of grey shades increases, the number of column voltage levels increases significantly. The reason for this can be seen by considering the normal method by which the column voltage signal is calculated. Equation (22) below restates the way in which the column vector, G, is calculated from the row matrix, F, and the information vector, A.

$${G}_{j} ( t ) = c {\sum }_{i = 1}^{N} {A}_{ij} {F}_{i} ( t ) \qquad ( 22 )$$

Let the number or rows multiplexed, N, be 8 and the row matrix be a L=4 MLA row matrix made up of two 4×4 Hadamard matrices, i.e.:

$$F = \frac{1}{2} [ \begin{matrix}1 & 1 & 1 & 1 & 0 & 0 & 0 & 0 \\ 1 & 1 & - 1 & - 1 & 0 & 0 & 0 & 0 \\ 1 & - 1 & 1 & - 1 & 0 & 0 & 0 & 0 \\ 1 & - 1 & - 1 & 1 & 0 & 0 & 0 & 0 \\ 0 & 0 & 0 & 0 & 1 & 1 & 1 & 1 \\ 0 & 0 & 0 & 0 & 1 & 1 & - 1 & - 1 \\ 0 & 0 & 0 & 0 & 1 & - 1 & 1 & - 1 \\ 0 & 0 & 0 & 0 & 1 & - 1 & - 1 & 1\end{matrix} ] \qquad ( 23 )$$

If the number of greyshades available in the display is set to be 16, i.e. 4-bit greyscale, then the information vector, A, can contain any values from the following set:

$$A ( i ) ∈ \frac{1}{15} \{ - 15 , - 13 , - 11 , - 9 , - 7 , … , - 1 , + 1 , … + 7 , + 9 , + 11 , + 13 , + 15 \} \qquad ( 24 )$$

This is consistent with the notation used by Scheffer et al in which grey shades are represented be values in the range −1 to +1. The sixteen possible values for each element of A and the four +/−1 elements in each row of F mean that the column vector described in Equation (22) may contain elements from the following set:

$$G ( j ) ∈ \frac{1}{30} \{ - 60 , - 58 , - 56 , - 54 , - 52 , … , - 2 , 0 , + 2 , … , + 52 , + 54 , + 56 , + 58 , + 60 \} \qquad ( 25 )$$

There are 61 members of this set, meaning that the column drivers must be able to produce 61 equally spaced voltage levels for this MLA system. When the row matrices are based on Hadamard matrices and zeros as in this case, a new relationship can be defined between the number of greyshades, 2^{B}, the value of L and the number of column voltage levels, Nᵥ:

N_{V}=(L×(2^{B}−1))+1 (26)

This equation actually is the general case of Equation (21), which was defined for bi-level pixel data i.e. B=1. It can be seen that the number of column voltage levels rises linearly with L and exponentially with B. To illustrate the large numbers involved, the results of Equation (26) are tabulated for various values of L and B in Table (1):

TABLE 1
The number of colunm voltage levels, as given by Equation (22),
tabulated for a range of values of L and B. Note how the number of
voltage levels in the colunm driver increases rapidly with L and
even more so with B.

| Greyscale | Number of simultaneously selected rows, L | | | | | | | | |
|---|---|---|---|---|---|---|---|---|---|
| bit depth B | 1 | 2 | 4 | 8 | 16 | 32 | 64 | 128 | 256 |
| 1 | 2 | 3 | 5 | 9 | 17 | 33 | 65 | 129 | 257 |
| 2 | 4 | 7 | 13 | 25 | 49 | 97 | 193 | 385 | 769 |
| 3 | 8 | 15 | 29 | 57 | 113 | 225 | 449 | 897 | 1793 |
| 4 | 16 | 31 | 61 | 121 | 241 | 481 | 961 | 1921 | 3841 |
| 5 | 32 | 63 | 125 | 249 | 497 | 993 | 1985 | 3969 | 7937 |
| 6 | 64 | 127 | 253 | 505 | 1009 | 2017 | 4033 | 8065 | 16129 |
| 7 | 128 | 255 | 509 | 1017 | 2033 | 4065 | 8129 | 16257 | 32513 |
| 8 | 256 | 511 | 1021 | 2041 | 4081 | 8161 | 16321 | 32641 | 65281 |

A typical value for the number of voltage levels in a conventional column driver IC would be around six or seven if MLA was not used and pixel data was bi-level. It is clear that the large numbers shown in Table (1) would required TFT-style column drivers that can output a continuous voltage range.

Methods of Reducing the Number of Column Voltage Levels

Work by T. N. Ruckmongathan

Table (1) shows that the number of column voltage levels increases both with the number of simultaneously selected rows, L, and the greyscale bit-depth, B. In the case where no greyscale is required, i.e. binary pixel values, some novel MLA schemes have been proposed by T. N. Ruckmongathan.^{[8]} For his PhD thesis, Ruckmongathan proposed using row matrices that were made up of every possible binary pattern of length N. These matrices were neither orthonormal nor square and so they deviated from the normal Nehring and Kmetz approach. His so-called Binary Addressing Technique (BAT) used only two voltage levels for the row matrix and two for the column matrix. At each iteration of the addressing process, the number of mismatches between the applied pattern and the desired image pattern was used to decide which polarity of column voltage to use. The BAT method was successful in being very cheap to implement but suffered from two main drawbacks. The first was that the number of addressing time-slots in the row matrix was 2^{N} where N is the number of rows. This meant that it was only viable for small values of N. The second problem was that the voltage selection ratio was significantly lower that the ideal Alt and Pleshko value. To counter both of these problems, Ruckmongathan developed extended versions of his addressing scheme. The best overall compromise was known as IHAT-S3, which had the following characteristics. Rather than addressing all rows in one go, the new scheme segments the N rows into blocks of L, each of which is addressed using the BAT row waveform. The number of column voltage levels in increased from two to three, leading to selection ratios much closer to the ideal value. The IHAT-S3 scheme has formed the basis of at least one commercial MLA system produced in collaboration between the Optrex Corporation and the Asahi Glass Company both of Japan.^{[11]}.

A more complicated situation occurs when greyscale is required in the display as well as multiple line addressing. The two greyscale generation techniques described above both require TFT-style column drivers to produce the wide range of column voltages needed. In order to reduce the number of column voltage levels, an alternative approach would be to consider a form of temporal dithering such as frame-rate control (FRC) or pulse-width modulation (PWM). Both of these methods can dramatically reduce the number of column voltage levels required although there is a trade-off in each case. The FRC method treats a greyscale image as a sequence of binary bitplanes and displays the sequence very rapidly to cause the human eye to perceive grey levels. The number of bitplane frames, N, required to address a greyscale image of bit-depth, B, is given as:

N=2^{B}−1 (27)

Therefore, an eight-bit greyscale image will require 255 bitplanes to be displayed in order to create each greyscale frame. This requires a corresponding 255-fold increase in addressing frequency, which can lead to increased power consumption and problems with image distortion caused by high-frequency effects in the panel. The only difference between FRC and PWM is that the latter does not restrict itself to equal addressing periods for each bitplane. Instead of repeating the bitplanes certain numbers of times depending on their significance, PWM changes the length of the bitplane period accordingly. In fact, the distinction between FRC and PWM is largely academic since they can produce virtually identical voltage waveforms.

Of course, when MLA drive schemes are being used, the number of column voltage levels required to address even a binary bitplane increases as L+1, with L being the number of simultaneously selected rows. Therefore, taking the example of a 6-bit greyscale image addressed using L=4 MLA, the FRC approach would require 63 dithered bitplanes per greyscale frame, each using 5 column voltage levels. The 63-fold increase in frame frequency that this implies would almost certainly lead to unacceptably large frequency-related image distortion.

Example of Proposed New System Architecture

Synergy Between MLA and Image Compression Techniques

One of the most common functions used to create MLA row matrices is the Hadamard matrix. As well as being the basis for the ‘Active Addressing’ schemes developed by Scheffer et al, Hadamard matrices are also widely used for MLA systems that select a small number of rows at a time. The reason why this is so interesting is the fact that Hadamard matrices have been evaluated in the past for use in image coding and compression applications. In fact, Hadamard matrices are not generally used for practical image coding techniques since their binary nature leads to a high incidence of blocky artefacts as quantisation step sizes increase. Nevertheless, this example of using the same mathematical functions for both MLA and image coding applications is very attractive since it suggests that there may be considerable synergy between two previously unrelated areas. A further element that gives scope to this idea is Nehring and Kmetz's proof that any orthonormal matrix can be used to obtain optimum addressing performance. This is a licence for a lot of flexibility in terms of choosing row matrices that are useful for image coding applications as well as MLA systems. An ideal system could be imagined in which the dual tasks of image decompression and display driving were performed using the same circuitry leading to savings in space, cost and power-consumption. This is the goal of the work described below.

Calculation of the Column Matrix

The generalised way that the column matrix, G, is normally calculated in a MLA system is given by Equation (18) and is restated below:

G=cF⁻¹A (28)

where c is a scale factor, F¹ is the inverted row matrix, and A is the information matrix. In most forms of image coding and compression, the first step in the process is to apply a two-dimensional transform to the raw image. The purpose of this is to rearrange the information content of the image so that it is concentrated into a small number of transform coefficients. This allows near-zero coefficients to be approximated to zero in order to achieve compression. The two-dimensional transform operation can be represented by the following equation:

B=MAM^{T} (29)

where A is the original image matrix, M is the operation matrix and B is the transformed result matrix. Equations (28) and (29), taken together, potentially offer a method of relating the column matrix, G, to the compressed image matrix, B, without passing through the raw image matrix, A. If Equation (29) is rearranged by post-multiplying both sides by (M^{T})⁻¹ then it becomes:

B(M^{T})⁻¹=MAM^{T}(M^{T})⁻¹ =MA (30)

If the row matrix, F, is chosen to be the inverse of the transform matrix, M, i.e.:

F=M⁻¹∴M=F⁻¹ (31)

then the right hand side of Equation (30) becomes equal to the generalised expression for the column matrix, G, given in Equation (28), except for the scaling factor, c.

This result is important because it shows that a single matrix post-multiplication operation performed on a 2-D transformed coefficient matrix, B, results in a valid column matrix, G:

G=cB(M^{T})⁻¹ (32)

In the case when the transform matrix, M, is orthonormal, then the expressions for the row and column matrices can be simplified to:

F=M⁻¹=M^{T}

G=cB(M^{T})⁻¹=cBM (33)

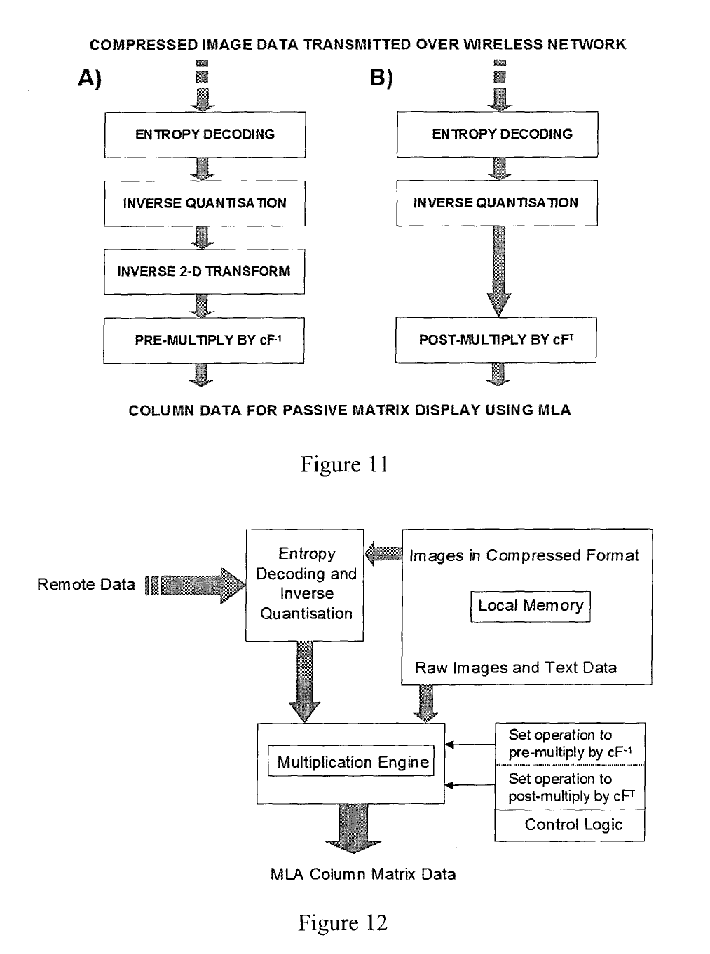

This idea forms the basis for a proposed new architecture for displays receiving compressed image data in accordance with an embodiment of the present invention. FIG. 11 compares the existing way that such operations are performed (labelled A) with the proposed new method (labelled B).

The obvious benefit of the new method is clearly shown in FIG. 11 since the inverse 2-D transform is no longer required. This represents a significant saving in memory, processing and power requirements compared to the existing method and so should be attractive to hardware manufacturers.

The data flow shown in FIG. 11 represents the case of a mobile device receiving and displaying streaming video data from a remote source. Obviously, for the majority of applications the data being displayed on the screen of the device will be held locally in a memory-mapped frame buffer or similar. It is important that the proposed new architecture be assessed for its applicability to this situation as well as the streaming video case. When locally held data is to be displayed on a MLA screen the column matrix must be calculated from the raw image data according to Equation (28). This involves pre-multiplying the raw image data by the scaled and inverted row matrix. Therefore, for both the remote and local data source cases, the processing required to calculate the column matrix is a single matrix multiplication operation. If the row matrix is orthogonal then F^{T}=F⁻¹ and the matrix used in the two cases is identical. FIG. 12 shows the logical architecture of such a system operating from both remote and local image data. It should be noted that compressed image data is treated the same, independently of whether it comes the local memory or from a remote source.

Selecting a Suitable Row Matrix

So far, little mention has been made of the choice of row matrix, F. It was the dual use of the Hadamard matrix that triggered this whole investigation but as mentioned above, the Hadamard matrix is not suitable for high quality image compression as it leads to blocky artefacts even at medium compression rates.

When considering potential candidates for use as row matrices in the proposed system, the following requirements are ideally met:

The matrix should be useful as an image compression function and if possible should be compatible with existing image compression standards.

The row matrix should select enough rows simultaneously to reduce frame response to an acceptably low level.

The matrix should ideally be orthogonal, or, failing that, at least linearly independent.

The matrix should be fairly sparse, so as to ease the computational load.

Ideally, the number of voltage levels in the row matrix should be as low as possible, although this may be incompatible with some of the other requirements.

The first of these requirements is perhaps the most restrictive in terms of the number of functions that it qualifies for consideration. However, it is critically important if the proposed system is to be useful for displaying images compressed using standard formats. The principal candidates that emerge for consideration are therefore the discrete cosine transform (DCT) and the discrete wavelet transform (DWT). Between the two of them, the DCT and DWT cover most of the current image compression standards, including the JPEG, JPEG2000, MPEG-1 and MPEG-2 and MPEG-4 standards. The two transforms are considered in turn below and assessed for their suitability in the proposed architecture.

A DCT-Based Row Matrix

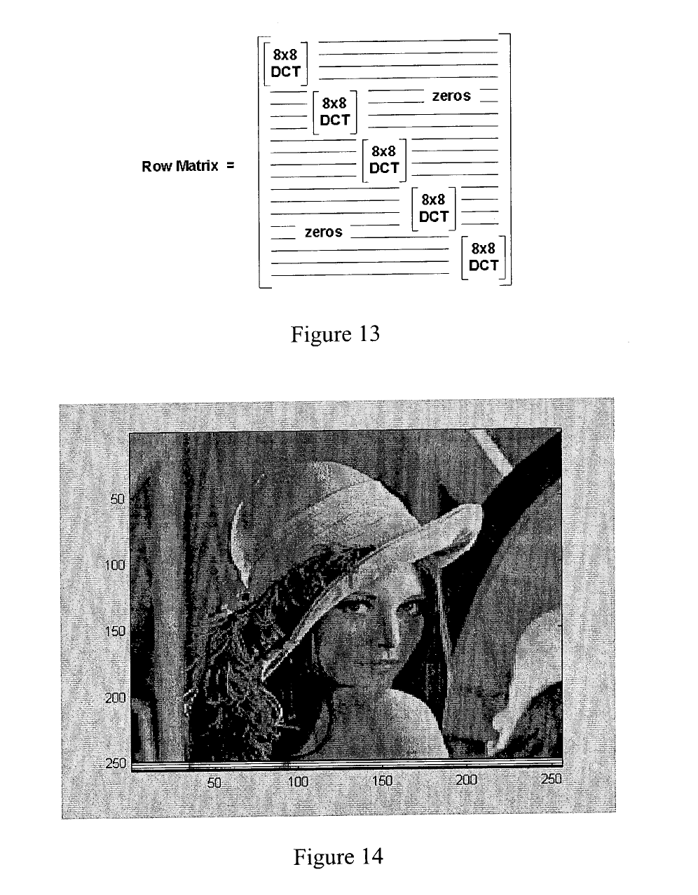

The normal block size used for DCT systems is 8×8 since this has been found to give an excellent trade-off between compression performance and reconstructed image quality. The 8×8 block is specified by most coding standards that used DCTs and so should be the basis for this investigation. From a MLA point of view, the 8×8 block size means that any row matrix based on the DCT will select eight rows simultaneously, i.e. L=8. The simplest way to construct an MLA row matrix from this DCT block is to repeat the blocks along the diagonal of an otherwise empty matrix as shown in FIG. 13. Exactly the same effect could be achieved by rearranging the rows of the matrix above in any order. The usual reason why rows are rearranged is to distribute the selection pulses more evenly through the matrix, thereby further reducing frame response.

The DCT block itself is a full-rank matrix so its rows are linearly independent as well as being normalised. In addition, the DCT is orthonormal, so its transpose is equal to its inverse. As a result, the row matrix shown in FIG. 13 is normalised, linearly independent and orthogonal.

In order to test the validity of such a row matrix in a MLA system, some simulations were performed. The first test case involved starting with a raw image matrix and calculating the column matrix according to Equation (28). The second test case used the new method of calculating the column matrix from a compressed image file, as given by Equation (32). In both cases, Matlab™ was used to simulate a MLA system based on the DCT row matrix.

The first simulation produced perfect results for both monochrome and greyscale images. The DCT-based row matrix was completely acceptable for use in a MLA system. Greyscale was achieved using both the split and full-interval methods without encountering any problems. The second simulation, using the new method of calculating the column matrix from the compressed image data, produced a mixed set of results. For monochrome images, the simulation produced perfect results. However, greyscale generation became a complicated issue due to the reasons explained below.

The full-interval greyscale method uses correction signals that are calculated from the raw image data according to Equation (10). The new method calculates the column matrix without having access to the raw image data, so the correction signals cannot be calculated in the normal way. In order to try and circumvent the problem, it is useful to realise the purpose of the correction signals. They are used to ensure that the vector magnitude of each column of the image matrix is equal, leading to a constant selection ratio between columns. Effectively, the correction signals normalise the columns of the column matrix. Bearing this in mind, an attempt was made to modify the full-interval greyscale method so that some correction signals were calculated from the column matrix itself rather than the image matrix. This would ensure the column matrix was normalised as required. The bottom row of the column matrix was replaced by correction signals calculated according to Equation (35).

$${V}_{( N ) j} = \sqrt{( N - 1 ) - {\sum }_{m = 1}^{N - 1} {G}_{mj}^{2}} \qquad ( 34 )$$

The image produced by the simulation that employed this technique is shown in FIG. 14. The bulk of the image is displayed perfectly, but it can be seen that the bottom eight rows of the image are totally distorted with horizontal stripe defects.

It is significant that it is eight rows that are distorted rather than any other number since the row matrix is based on the 8×8 DCT block. The fact that eight rows are selected simultaneously means that these eight rows are inter-dependent and if a change is made to one row of the column matrix then it will have an effect on seven other rows too. This is why distortion is seen in all eight rows in the bottom of the image.

It is clearly unacceptable to lose a portion of the image to distortion in this way. The solution to this problem stemmed from the explanation of why the distortion occurred, contained in the previous paragraph. Since there is an inherent link between each group of eight rows in the column matrix, eight dummy rows may be added to the column matrix. It could be that seven of these rows simply contain zeros and the eighth contains the correction signals. Alternatively, the correction signals could be distributed over all eight rows so as to reduce the maximum magnitude of the signals. This idea was simulated and was found to be completely successful. It is an elegant solution since it is very much in the spirit of the full-interval greyscale method itself. It would be less attractive if a 16×16 DCT block were used to form the row matrix since it would require sixteen dummy rows, but for the standard 8×8 case it is fine.

So it has now been shown that the full-interval greyscale method can be successfully applied to the new method of calculating the column matrix. The next step is to consider the other greyscale generation methods and determine if they too are suitable for this system. The split-interval greyscale method, as described above, requires the greyscale pixel values to be converted to X and Y variable values according to Equation (17). Since the preferred embodiment of the new method does not allow access to the original pixel values it is unclear how the split-interval scheme could possibly be implemented. As a result, it has been dismissed as a candidate for greyscale generation if the new system is used. The alternative ways of producing greyscale are FRC, PWM and the hybrid method developed above. The first two of these are in essence identical and both should work since simulations have already shown that monochrome ‘bitplanes’ can be successfully displayed using the new architecture. The FRC and PWM methods both achieve greyscale by temporal dithering of these bitplanes, so the only restriction will be the maximum dither frequency possible before distortion occurs. The hybrid method is also based on the idea of bitplanes although binary weighted voltages are used to drastically reduce the number of dither frames required. All three of these methods can be used without having to know the original pixel values since the bitplanes can be calculated directly from the column matrix.

In summary, DCT-based row matrices have been shown to be fully acceptable for use within MLA systems. Successful results have been obtained using both the standard and new methods of generating column matrices. Several different greyscale methods have been shown to be compatible with DCT-based MLA using the new architecture, although one of these, the full-interval method, was modified slightly in order to avoid localised image distortion.

A Wavelet-Based Row Matrix

Unlike the DCT, the discrete wavelet transform (DWT) is a parametric function in which the basic algorithm can be applied using many different sets of wavelet filter pairs. The result of the transform is therefore dependent on the choice of these wavelets, which makes evaluation of the DWT for use in MLA systems more complicated than the DCT case.

Choosing Suitable Wavelets

There is a very large number of wavelet filter pairs that can be used in the DWT, and in a sense it is an infinite number since new filter pairs can be created simply by manipulating existing ones. Therefore, when it comes to choosing which wavelets to select for assessment for this application, it is helpful to refer back to the preferred criteria outlined above. The first criterion to consider is that the row matrix formed using these wavelets must be useful as an image compression function and if possible be compatible with existing image compression standards. It could be said that the vast majority of wavelets are useful for image compression applications, although there is a wide variation in their effectiveness and complexity. However, as soon as the ‘image compression standards’ argument is introduced, the number of likely candidates rapidly reduces to a manageable figure.

Another criterion mentioned above is that the row matrix should ideally be orthogonal. It has already been shown that orthogonality is not necessarily required to produce images that are free from cross-talk, but it is required in order to achieve the optimum Alt and Pleshko selection ratio. Orthogonality is one of the major classifications used to describe wavelets and separate them into sub-sets. The definition of orthogonality for wavelets is related to the coefficients of the analysis and reconstruction filter banks. In an orthogonal filter bank the reconstruction bank is simply the transpose of the analysis bank. This means that the same filter coefficients are used in both banks but with opposite ordering. The orthogonality constraint is mathematically elegant but is quite restrictive so not many filter sets satisfy it. The best known examples of orthogonal wavelets are the simple Haar wavelets and the Daubechies 4-tap wavelets. Both of these are good candidates for investigation since they represent the simplest cases, although neither is used in practical image compression standards. A larger and more practical set of wavelets are those that are classed as being ‘bi-orthogonal’. In a bi-orthogonal filter bank the number of filter coefficients in the low and high-pass filters is not equal so the analysis and reconstruction filter banks cannot be the inverse of each other. Instead the two banks are ‘pseudo-inverses’ meaning that the rows of the analysis bank are orthogonal to the columns of the reconstruction bank. Most of the wavelets used in real image compression applications and standards are bi-orthogonal so this is the more interesting set to consider for use in the MLA system. However, the lack of true orthogonality suggests that any row matrix formed from bi-orthogonal wavelets will itself not be orthogonal. The effect of this will be one of the main aims of the investigation.

Representing the DWT as a Matrix

The DWT has so far been represented as a filtering operation. During the DWT process itself, a finite length vector with L components is transformed into L wavelet coefficients. This transform can therefore be represented as an L×L matrix operating on the input vector to produce the coefficient vector. The DWT filter bank process contains three key features that are incorporated into the matrix representation. The first of these is the filtering itself, which in the matrix is simply represented by the filter coefficients. Each element of the output vector is formed as the dot product of the input vector with a row of the coefficient matrix. Therefore the dot product calculation is effectively a convolution or filtering operation.

The second part of the DWT algorithm that is represented in matrix form is down-sampling by a factor of two. In the matrix structure, down-sampling is represented by the two-element offset between filter coefficients in consecutive rows. For example, if the filter coefficients on the first row start at the first column, then in the second row they will start at the third column and on the third row they will start on the fifth column etc. The down-sampling ensures that the total number of low-pass and high-pass filter coefficients at the end of the process equals the number of starting elements.

The third element of the DWT algorithm that is represented in matrix form is the concept of having several scales of resolution. The low-pass coefficients that have been generated by the first scale of filtering become the input to the second stage of filtering and so on. Each scale of filtering is represented as a separate transform matrix and the overall multi-scale transform matrix is obtained by multiplying these single-scale matrices together. When writing down the transform matrices for scales two and higher, care must be taken with the filter coefficient positions, since not all of the preceding output coefficients will need to be operated on at the later scale. Equation (59) illustrates all of these points by means of a simple example.

$$A = [ \begin{matrix}r & r & & \\ r & - r & & \\ & & 1 & \\ & & & 1\end{matrix} ] [ \begin{matrix}r & r & & \\ & & r & r \\ r & - r & & \\ & & r & - r\end{matrix} ] \qquad ( 35 )$$

The analysis matrix, A, represents a two-scale DWT using simple Haar wavelets. The matrix on the right represents the first scale of decomposition, with the low-pass coefficients in the top half and the high-pass coefficients in the lower half of the matrix. Note how downsampling is represented by the two-element offset between rows one and two and also between rows three and four. The left-hand matrix of the two represents the second scale of filtering. The low-pass coefficients are only on the first row and the high-pass coefficients only on the second row. Rows three and four are simply represented by an identity matrix since no operation is performed on them. If notation is introduced such that the low-pass coefficients are represented by a matrix L, and the high-pass coefficients by a similar matrix H, then a three-scale, eight-element DWT matrix would look like FIG. 15. Note how successive scales, shown right to left, halve the number of low-pass and high-pass coefficients each time.

Boundary Issues

The matrix that is shown in Equation (59) uses the Haar wavelet, which only has two low-pass and two high-pass coefficients. However, this is an unrepresentative case since all other wavelets have more than two coefficients. This leads to the necessity of considering how to deal with the edges of the matrix where there is not enough space to fit in all of the coefficients. There are three principal ways of dealing with the boundary issue, each of which has its own particular consequences in terms of the effects on image quality and computation. In order to illustrate the different methods, consider a case in which the low-pass filter coefficients, h₀, are given by:

h₀={a,b,c,b,a} (36)

Similarly, the high-pass coefficients, h,, are given by:

h₁={d,e,d} (37)

Note that for both the low and high-pass coefficients, there is symmetry about the central coefficient, so variable names can be repeated. If these filters were used to create an 8×8, single-scale DWT matrix and the boundaries of the matrix were temporarily ignored then the situation would look like Equation (39).

$$F = \begin{matrix}a & b\end{matrix} [ \begin{matrix}c & b & a & & & & & & \\ a & b & c & b & a & & & & \\ & & a & b & c & b & a & & \\ & & & & a & b & c & b & \\ d & e & d & & & & & & \\ & & d & e & d & & & & \\ & & & & d & e & d & & \\ & & & & & & d & e & \end{matrix} ] \begin{matrix}a \\ d\end{matrix} \qquad ( 38 )$$

The first method is simply to ignore any coefficients that do not fit into the matrix. An example of what this would look like in a matrix is shown in Equation (40).

$$F = [ \begin{matrix}c & b & a & & & & & & \\ a & b & c & b & a & & & & \\ & & a & b & c & b & a & & \\ & & & & a & b & c & b & \\ d & e & d & & & & & & \\ & & d & e & d & & & & \\ & & & & d & e & d & & \\ & & & & & & d & e & \end{matrix} ] \qquad ( 39 )$$

Although this is the simplest method, it causes severe problems in the image compression performance of the DWT since it means that some parts of the image are treated differently to other parts. Rows 1, 4 and 8 of the DWT matrix are missing coefficients, leading to errors being produced. The missing coefficients also mean that the vector magnitude of the different rows is no longer constant, even within the low-pass or high-pass halves of the matrix. This method is not considered to be viable in image compression algorithms and so it is unsuitable for the creation of DWT-based row matrices.

The second method of dealing with the boundary issue is known as ‘data wraparound’. As the name suggests, coefficients that do not fit into the matrix are wrapped around to the other side as shown in Equation (41).

$$F = [ \begin{matrix}c & b & a & & & & a & b \\ a & b & c & b & a & & & \\ & & a & b & c & b & a & \\ a & & & & a & b & c & b \\ d & e & d & & & & & \\ & & d & e & d & & & \\ & & & & d & e & d & \\ d & & & & & & d & e\end{matrix} ] \qquad ( 40 )$$

This approach is better than the previous method since no coefficients are discarded and the vector magnitude of the rows is kept constant. However, the underlying assumption of this method is that the data being operated on is periodic. If the data is indeed periodic and of the same for the matrix then this method will give perfect results. However, most image data is not periodic and in this case the data-wraparound method leads to objectionable visual artefacts being created by the transform. For this reason, the data-wraparound method is not very attractive for use in the MLA system to create the DWT-based row matrices.

The third method is the one that is widely used in image compression standards. It is called ‘symmetric extension’ and the basic idea is to imagine the edges of the matrix as mirrors so that any ‘overhanging’ coefficients are reflected back. These reflected coefficients are added to the existing coefficients in order to create composite values. Unlike the previous two methods, both of which lead to a ‘jump’ in the function, symmetric extension leads to a jump in the first derivative of the function, which is much less noticeable. Equation (42) shows the example matrix after symmetric extension.

$$F = [ \begin{matrix}c & 2 b & 2 a & & & & & \\ a & b & c & b & a & & & \\ & & a & b & c & b & a & \\ & & & & a & b & ( c + a ) & b \\ d & e & d & & & & & \\ & & d & e & d & & & \\ & & & & d & e & d & \\ & & & & & & 2 d & e\end{matrix} ] \qquad ( 41 )$$

It is not necessarily obvious what is going on in Equation (42) since it is more intuitive to think of the data sequence being extended rather than using the matrix to describe the operation. Consider a data sequence, D, containing eight elements, D₀ to D₇. If the DWT matrix shown in Equation (42) were applied to D, the resulting vector would be:

$$[ \begin{matrix}{cD}_{0} + 2 {bD}_{1} + 2 {aD}_{2} \\ {aD}_{0} + {bD}_{1} + {cD}_{2} + {bD}_{3} + {aD}_{4} \\ {aD}_{2} + {bD}_{3} + {cD}_{4} + {bD}_{5} + {aD}_{6} \\ {aD}_{4} + {bD}_{5} + ( c + a ) {D}_{6} + {bD}_{7} \\ {dD}_{0} + {eD}_{1} + {dD}_{2} \\ {dD}_{2} + {eD}_{3} + {dD}_{4} \\ {dD}_{4} + {eD}_{5} + {dD}_{6} \\ 2 {dD}_{6} + {eD}_{7}\end{matrix} ] \qquad ( 42 )$$

If the original matrix shown in Equation (39) were to be applied to D then it would be necessary to extend D with some extra terms. For example, if D₋₂ and D₋₁ were attached to the start of the sequence and D₈ added to the end, then the original matrix, operating on this extended sequence, would produce the following vector:

$$[ \begin{matrix}{aD}_{- 2} + {bD}_{- 1} + {cD}_{0} + {bD}_{1} + {aD}_{2} \\ {aD}_{0} + {bD}_{1} + {cD}_{2} + {bD}_{3} + {aD}_{4} \\ {aD}_{2} + {bD}_{3} + {cD}_{4} + {bD}_{5} + {aD}_{6} \\ {aD}_{4} + {bD}_{5} + {cD}_{6} + {bD}_{7} + {aD}_{8} \\ {dD}_{0} + {eD}_{1} + {dD}_{2} \\ {dD}_{2} + {eD}_{3} + {dD}_{4} \\ {dD}_{4} + {eD}_{5} + {dD}_{6} \\ {dD}_{6} + {eD}_{7} + {dD}_{8}\end{matrix} ] \qquad ( 43 )$$

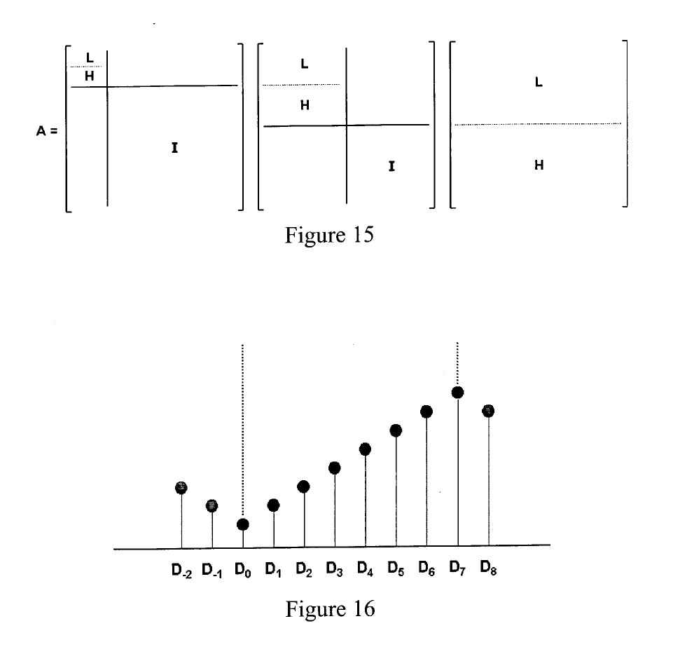

If the additional terms, D₋₂, D₋₁ and D₈ are created using symmetric extension, then FIG. 16 will represent the way that they are related to the original sequence D₀ to D₇. The pivot points are marked by the dotted lines. In this case the pivot points are data points since there is an odd number of coefficients for both the low-pass and high-pass filters. For even length filters, the pivot point will lie between two data values.

As FIG. 23 illustrates, the mirror effect of symmetric extension means that:

D₋₂=D₂ D₋₁=D₁ and D₈=D₆ (44)

If these substitutions are made in the vector of Equation (44) then the original result from Equation (43) is obtained. Therefore, it becomes clear that the matrix in Equation (42) operating on the normal length data sequence is exactly equivalent to the full matrix from Equation (39) operating on the symmetrically extended data sequence of FIG. 16. It is important to ensure that symmetric extension of a data sequence is done in such a way that symmetry is preserved after downsampling. This requirement leads to a rule about the position of the pivot point in the data, denoted by a dotted line in FIG. 16. The rule states that if the number of filter coefficients is odd, then the data must pivot about a data point, otherwise the pivot point is half way between two data points. In the example above, the low-pass filter has five coefficients and the high-pass filter has three, hence the pivot points at D₀ and D₇.

Since symmetric extension is the standard method of dealing with the boundary issue it is also the method that will be used to create the wavelet-based MLA row matrices. However, unlike the data wraparound method, symmetric extension does not preserve the vector magnitude of the matrix rows. This trade-off could potentially cause a problem in the addressing performance of such a row matrix, although it is difficult to predict how significant this will be at this stage.

Orthogonal Wavelets

As mentioned above, there are a few sets of wavelets, such as the Haar and Daubechies 4-tap, that are orthogonal and should form orthogonal DWT matrices. These orthogonal wavelets were the first to be evaluated in simulations of the standard and the new MLA architecture. The wavelet coefficients were used to construct a row matrix according to the method outlined above and using the symmetric extension technique described above. The Haar wavelet coefficients are:

$$\begin{matrix}{h}_{0} = \frac{1}{\sqrt{2}} \{ 1 \; 1 \} \\ {h}_{1} = \frac{1}{\sqrt{2}} \{ 1 - 1 \}\end{matrix} \qquad ( 45 )$$

The Daubechies 4-tap wavelet coefficients are:

$$\begin{matrix}{h}_{0} = \frac{1}{4 \sqrt{2}} \{ ( 1 + \sqrt{3} ) ( 3 + \sqrt{3} ) ( 3 - \sqrt{3} ) ( 1 - \sqrt{3} ) \} \\ {h}_{1} = \frac{1}{4 \sqrt{2}} \{ ( - 1 + \sqrt{3} ) ( 3 - \sqrt{3} ) ( - 3 - \sqrt{3} ) ( 1 + \sqrt{3} ) \}\end{matrix} \qquad ( 46 )$$

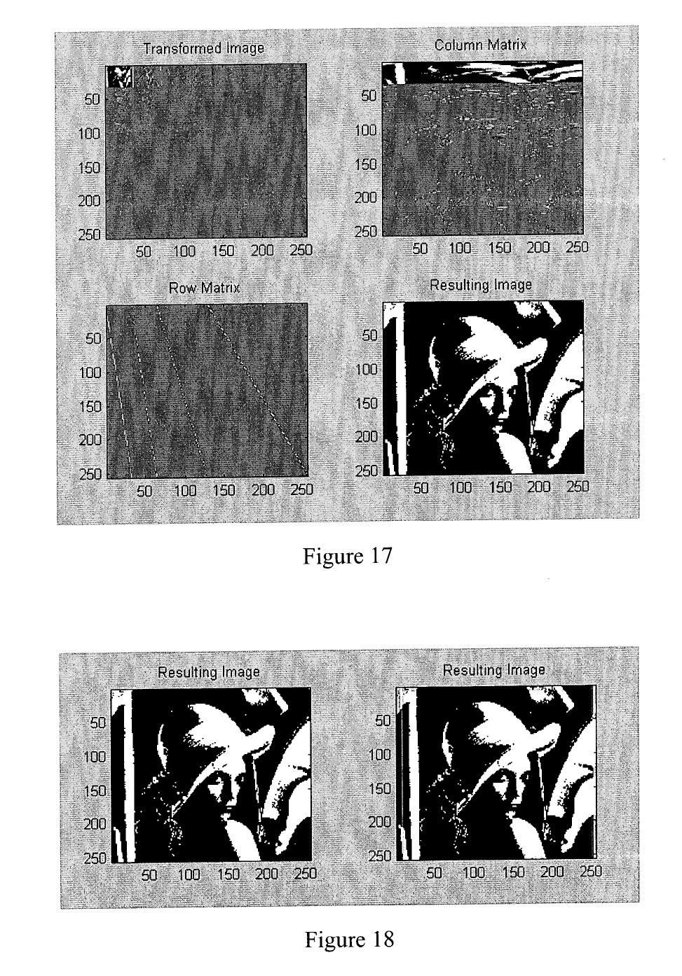

The first simulation used the Haar wavelet to make a three-scale DWT-based row matrix. Initially, a monochrome image was used since this is a simpler case than a greyscale image. Using the standard method of generating the column matrix from the raw image, perfect results were obtained. When the new method was simulated, calculating the column matrix from the compressed image, the results shown in FIG. 17 were obtained. The column matrix (shown top right) was generated from the 2-D compressed image (shown top left) according to the new method. The row matrix (shown bottom left) is a transposed version of the three-scale DWT matrix using the Haar wavelet. The resulting image (shown bottom right) was completely free of error and showed that the method was valid at least for monochrome images. In addition, since the row matrix was orthogonal, the selection ratio obtained in the simulation reached the optimum Alt and Pleshko value. It is interesting to note that the column matrix, shown in FIG. 17, is clearly identifiable as a 1-D transformed version of the image to be displayed. It is a powerful demonstration of how the addressing process itself performs the second 1-D transform inherently.

The next simulation again used a monochrome image but this time the row matrix was created from the Daubechies 4-tap wavelet coefficients shown in Equation (47). Since there are four filter coefficients, rather than the two for the Haar case, it was necessary to use the symmetric extension technique from above. The simulations using the standard and new methods both yielded the same result. FIG. 18 shows the target image on the left hand side and the actual generated image on the right hand side. Looking carefully at the generated image it is possible to see some vertical stripe artefacts on both edges of the image. Since the only difference between the Haar and Daubechies cases was the symmetric extension technique, it became the obvious culprit. In order to investigate why the errors occurred, the row-matrix was examined carefully. When the vector magnitude of the rows was measured, a non-uniformity was found.

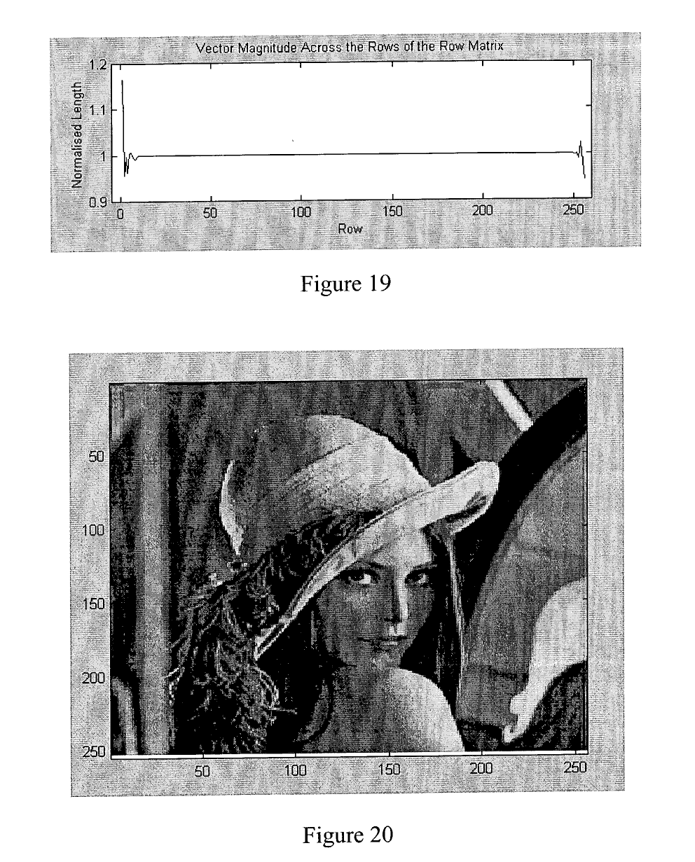

FIG. 19 shows the plot of vector magnitude across the rows. It is clear to see that the non-uniformity in row magnitude is significant and it is hardly surprising that some visible artefacts have appeared during the simulation.

Rather than going on to test a greyscale image using the DWT-based row matrices, the next aim of the investigation was to eliminate the vertical stripe artefacts seen in the last simulation. The obvious thing to try was simply to normalise the row matrix since it was the variation in row magnitude that was causing the problem. The simulation was modified to include a normalise function, applied to the rows of the row matrix. It was found that when the old method of generating the column matrix was used, prior normalisation of the row matrix led to the stripe defects disappearing. However, when the new method of generating the column matrix directly from the compressed image was used, normalising the row matrix did not solve the problem. These results can be explained by realising that it is actually non-normalisation of the column matrix that causes the problem rather than non-normalisation of the row matrix. In the old method of generating the column matrix, given by Equation (7), if the row matrix is normalised then the column matrix will automatically be normalised for a monochrome image. However, if the new method is used and the column matrix is calculated according to Equation (33), then the column matrix could still be non-normalised after it has been post-multiplied by F^{T} even if F itself is normalised. Therefore, it makes more sense to normalise the column matrix directly, after it has been calculated and before it is used. By doing this, the new method yielded perfect results for the row matrix based on the Daubechies 4-tap wavelets.

The idea of normalising the columns of the column matrix has been encountered before as the underlying principle of the full-interval greyscale method. This suggests that if the full-interval method were to be used with wavelet-based MLA then it could achieve a dual purpose. Obviously, the first consequence would be that greyscale images could be addressed. However another benefit would be the elimination of any vertical stripe defects that may otherwise have been caused by the wavelet-based row matrix. To test this theory, some further simulations were performed. The Haar wavelet-based row matrix produced perfect greyscale performance using the full-interval method. The Daubechies wavelet-based row matrix produced the result shown in FIG. 20. It can be seen that the majority of the image has been perfectly produced but there are some artefacts along all four edges of the image. The white stripe across the bottom of the image is the most serious problem in terms of image artefacts. This is caused by the large magnitude of the correction signals and the fact that the bottom few rows are selected simultaneously so they all are affected by the correction signals. A way to get rid of this type of stripe has already been presented above and it involves adding some dummy rows to the bottom of the column matrix and extending the row matrix accordingly. A further simulation was performed in order to verify that the white stripe could really be removed in this way. It was successful and confirmed the validity of the stripe-removal technique.

The simulations using the row matrices based on orthogonal wavelets showed that the proposed system was valid and produces good results. The Haar wavelet produced perfect results and the Daubechies wavelet was near perfect as shown by FIG. 20. The white stripe at the base of the image in FIG. 20 was successfully removed by the addition of four dummy rows in the column matrix, leaving only a few minor imperfections.

Biorthogonal Wavelets

The use of bi-orthogonal wavelets in the new system was a major goal since all of the wavelet filters used in practical image compression standards are bi-orthogonal. The recent JPEG2000 standard supports two different bi-orthogonal wavelets. The first one of these is the LeGall 5,3 wavelet, whose filter coefficients are given in Equation (48).

$$\begin{matrix}{h}_{0} = \frac{1}{8} \{ \begin{matrix}- 1 & 2 & 6 & 2 & - 1\end{matrix} \} \\ {h}_{1} = \frac{1}{4} \{ \begin{matrix}- 1 & 2 & - 1\end{matrix} \}\end{matrix} \qquad ( 47 )$$

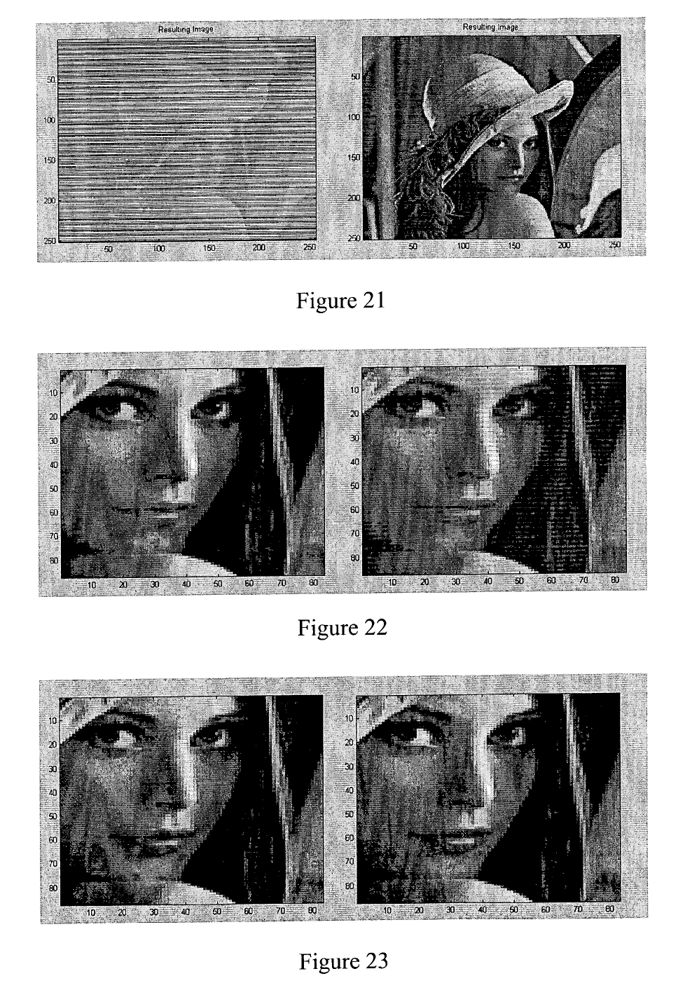

As mentioned above, one of the characteristics of bi-orthogonal wavelets is that the low and high-pass filters may have different numbers of coefficients. It can be shown that a consequence of this fact is that a row matrix formed from bi-orthogonal wavelets will not be normalised. Variations in vector magnitude between rows are caused both by the symmetric extension technique and the different vector magnitudes of the coefficient vectors themselves. When the row-matrix formed from the LeGall wavelet was simulated, the left-hand image shown in FIG. 21 was obtained.

It was quite surprising to see how severe the horizontal stripe defects were as a result of this variation in row magnitude within the row matrix. To counter the problem, the row matrix was normalised before it was used in the simulation. The resulting image is shown on the right hand side of FIG. 21 and was a great improvement over the non-normalised case. Some horizontal banding was still present, but it was sufficiently faint that the image looked quite good. The extent of the banding in the normalised case can be seen more clearly in FIG. 22, which compares a close-up section of the simulated image with the ideal case.

The banding in the normalised case is caused by the fact that normalisation changes the value of the filter coefficients so the inverse transform operation, performed during the addressing process itself, incorporates a slight error. The banding occurs on alternate rows of the image, so this suggests that the low-pass and high-pass filter coefficients have been multiplied by different values during the normalisation process. It is interesting to note that the two possible options both lead to errors being introduced, but in one case the visual artefacts are much more severe that the other. The first option, shown by the left-hand image in FIG. 21, performs a perfect inverse transform, but uses a non-normalised row matrix. This case yields terrible image quality. The second case normalises the row matrix, thereby introducing errors into the inverse transform operation, but this yields a much better quality image. The conclusion of this is that the addressing requirement of having a normalised row matrix is much more important that the requirement of having a perfect inverse transform. This is a somewhat surprising result.

The other filter used in the JPEG2000 standard is the Daubechies 9,7 wavelet, whose coefficients are given by Equation (49). Simulations were performed using MLA row matrices constructed from these filter coefficients. The steps that had been employed in earlier simulations to improve image quality were also applied in these later simulations. These included normalisation of the row matrix, use of the full-interval greyscale method and the addition of dummy rows to the bottom of the column matrix.

$${h}_{0} = [ \begin{matrix}0.0267 \\ - 0.0169 \\ - 0.0782 \\ 0.2669 \\ 0.6029 \\ - 0.0782 \\ - 0.0169 \\ 0.0267\end{matrix} ] {h}_{1} = [ \begin{matrix}0.0456 \\ - 0.0288 \\ - 0.2956 \\ 0.5575 \\ - 0.2956 \\ - 0.0288 \\ 0.0456\end{matrix} ] \qquad ( 48 )$$

It was found that the Daubechies 9,7 wavelets produced a better image than the LeGall 5,3 wavelets since the severity of the stripe defects was much less. FIG. 23 shows the image produced during this simulation. Also shown in FIG. 30 are the results of another simulation done with the so-called ‘Near-Symmetric’ 5,7 wavelet filter coefficients. These coefficient values are given in Equation (50).

$${h}_{0} = [ \begin{matrix}- 0.05 \\ 0.25 \\ 0.60 \\ 0.25 \\ - 0.05\end{matrix} ] {h}_{1} = [ \begin{matrix}0.0107 \\ - 0.0536 \\ - 0.2607 \\ 0.6071 \\ - 0.2607 \\ - 0.0536 \\ 0.0107\end{matrix} ] \qquad ( 49 )$$

The near-symmetric filter is one of the candidates that have been assessed for use in the MPEG-4 video compression standard. It can be seen that the right-hand image in FIG. 23, which resulted from the Near-Symmetric 5,7 simulation, looks virtually perfect in spite of the row matrix being normalised.

The extent of the horizontal striping that occurs for the different wavelets is obviously variable and is affected by the normalisation of the row matrix. In order to try and understand why the Near-Symmetric 5,7 wavelet should produce such good results, the vector magnitudes of the various coefficient vectors were calculated for the different wavelets. The vector magnitudes were calculated as:

$$magnitude = \sqrt{{\sum }_{i = 1}^{N} {h}_{x}^{2} ( i )} \qquad ( 50 )$$

Where x=0 represents the low-pass filter and x=1 the high-pass filter. N is simply the number of coefficients in the filter.

The results of the calculations are tabulated in Table (4) and they show that there is a correlation between the difference in vector magnitudes of h0 and h1, and the amount of horizontal stripe defects visible.

TABLE 4
The magnitudes of the coefficient vectors are displayed for the
different biorthogonal wavelets. The calculation used to obtain
these figures is given by Equation (74). There is clearly a large
difference in magnitudes for the LeGall 5,3 case, which ties in with
severe horizontal stripe defects being produced for this wavelet.

| | Magnitude | Magnitude | Difference in |
|---|---|---|---|
| Wavelet | of h0 | of h1 | magnitudes (%) |
| LeGall 5,3 | 0.7188 | 0.3750 | 47.8 |
| Daubechies 9,7 | 0.5202 | 0.4915 | 5.5 |
| Near-Symmetric 5,7 | 0.4900 | 0.5105 | 4.0 |

These results cannot claim to be anything other than indications of a pattern since examination of FIGS. 22 and 23 shows that the stripe defects in the LeGall 5,3 case are not nine times more severe than those in the Daubechies 9,7 case. It is clear that the severity of visual defects is not linearly related to the difference in vector magnitudes of the coefficient vectors. The calculation of coefficient vector magnitudes does not take into account the effects of symmetric extension or the fact that several scales of filtering can be represented in the row matrix. A more accurate metric of the effect of normalisation can be obtained by examining the row matrices themselves. If the variations in row magnitude are measured for the three different row matrices then the following results are obtained.

TABLE 5
For each of the three bi-orthogonal wavelet cases, the variation in
row magnitude within the row matrix is measured. The amount of
variation within the row matrix varies between the three cases in
the same way as the amount of visual distortion.

| | Ratio of maximum to minimum row |
|---|---|
| Wavelet used to create row matrix | magnitudes within the row matrix |
| LeGall 5,3 | 2.3333 |
| Daubechies 9,7 | 1.8069 |
| Near-Symmetric 5,7 | 1.4790 |

In all three cases, the row matrix represented a single-scale DWT operation using symmetric extension to deal with the boundary issue. It can be seen from Table (5) that there is a significant variation in row magnitude in all three cases, but the amount increases from the Near-Symmetric 5,7 to the Daubechies 9,7 to the LeGall 5,3 wavelets. Again, this is consistent with the visual results in FIGS. 22 and 23.

As well as subjective analysis of the images produced by the simulations, it was decided to make some measurements of errors. Although numerical error values in images are not always consistent with human perception of errors, it is still interesting to look at objective figures. The metric used to measure the amount of error is described by Equation (52).

$$Error = {\sum }_{i = 1}^{N} {\sum }_{j = 1}^{M} {\vert \hat{A} ( i , j ) - A ( i , j ) \vert}^{2} \qquad ( 51 )$$

It is a simple sum of the squared difference between the actual image, Â, and the ideal image, A. The dimensions of the images are defined as being N×M pixels, with i and j being used as parameters in the y and x directions respectively. It was decided to separate the error measurement from any variation in selection ratio since the latter can be compensated for by having a steep electro-optic liquid crystal response. To ensure that the error measurement was decorrelated from the selection ratio, the pixel values were normalised according to two reference pixel values, set to fully on and fully off in the top left comer of each image. The reference image was also normalised between the same values of one and zero. The error values obtained for the different wavelets are tabulated in Table (6).

TABLE 6
For each of the three bi-orthogonal wavelet cases, the error
between the simulated and target images is calculated according to
Equation (52). The results show that the Near-Symmetric 5,7 wavelet
produces least error and that the Daubechies 9,7 and LeGall 5,3
wavelets produce approximately four and nine times more error
respectively.

| Wavelet used to | Error measured according |
|---|---|
| create row matrix | to Equation (52) |
| LeGall 5,3 | 197.23 |
| Daubechies 9,7 | 82.50 |
| Near-Symmetric 5,7 | 21.99 |

Although, the error metric is somewhat arbitrary in nature, it does show that the error measured numerically correlates well with the visual perception of error as shown by FIGS. 29 and 30. It also follows the same trend as the measurements of variation in row magnitude tabulated in Table (5).

The simulations performed using row matrices formed from bi-orthogonal wavelets have proved that such systems are valid. The lack of orthogonality within the row matrix has led to the need to normalise the row matrix. This in turn has produced errors in the inverse wavelet transform process, manifested as artefacts in the final image. The amount of error varies between wavelets, with the Near-Symmetric 5,7 wavelet performing best, followed by the Daubechies 9,7 and the LeGall 5,3 wavelets. In all three cases, the final images have been of good quality, thereby showing that the proposed architecture is valid with existing wavelet-based image compression standards.

Conclusion

The successful results mean that a DCT-based MLA system would be compatible with several existing image compression standards including JPEG, MPEG-1 and MPEG-2. In addition, a wavelet-based MLA system would be compatible with the JPEG2000 and MPEG-4 standards. The efficient architecture shown by way of example in FIG. 12 could be used to reduce computational, memory and power-consumption overheads when displaying such compressed images on for example a mobile device.

Embodiments of the present invention have been described with particular reference to the examples illustrated. However, it will be appreciated that variations and modifications may be made to the examples described within the scope of the present invention.

References

1. T. J. Scheffer, J. Nehring, “Supertwisted-Nematic (STN) LCDs”, SID Symposium Seminar M-2, 1996.

2. J. Nehring, A. Kmetz, “Ultimate Limits for Matrix Addressing of RMS-Responding Liquid-Crystal Displays”, IEEE Trans. Electron. Devices, Vol. ED-26, No.5, May 1979.

3. P. Alt, P. Pleshko, “Scanning Limitations of Liquid Crystal Displays”, IEEE Trans. Elec. Dev., Vol ED-21, 1974.

4. T. J. Scheffer, B. Clifton, “Active Addressing Method for High-Contrast Video-Rate STN Displays”, SID Digest, Vol.23, pp228-231, (1992).

5. A. R. Conner, T. J. Scheffer, “Pulse-Height Modulation (PHM) Gray Shading Methods for Passive Matrix LCDs”, Proceedings of the 12th International Displays Research Conference, pp69-72, (1992).

6. A. Kawaji, K. Nakanishi, K. Kumagawa, “Crosstalk Simulations of Passive-Matrix LCDs Using the Principle of Superposition”, SID Digest, Vol. 27, pp569-572, (1996).

7. T. N. Ruckmongathan, “Addressing Techniques for RMS Responding LCDs”, Proc. 12 International Display Research Conference, pp77-80, (1992).

8. T. N. Ruckmongathan, “Some New Addressing Techniques for RMS Responding Matrix LCDs”, PhD Thesis Submitted to Indian Institute of Science, Bangalore, India, February 1988.

9. T. Otani, K. Kumagawa, K. Nakanishi, M. Matsunami, Y. Fukai, T. Matsumoto, “Investigation of Active Drive Method for STN-LCDs”, SID Digest, Vol. 26, pp343-346, (1995).

10. K. E. Kuijk, A. V. Henzen, R. Smid, “Minimum-Voltage Driving of STN-LCDs by Optimized Multiple-Row Addressing”, Proc. 19th International Display Research Conference, pp77-80, (1999).

11. S. Ihara, Y. Sugimoto, Y. Nakagawa, T. Kuwata, H. Koh, H. Hasebe, T. N. Ruckmongathan, “A Color STN-LCD with Improved Contrast, Uniformity and Response Times”, SID Digest, Vol. 23, pp232-235, (1992).

1. A method of driving a display device to display an image thereon in accordance with image data, the display device having a first set of electrodes and a second set of electrodes which are addressed with a first set of drive signals and a second set of drive signals respectively in order to drive pixels of the display device, the first set of drive signals being predefined, the image data being compressed, the method comprising:
obtaining the second set of drive signals from the compressed image data; and,
addressing the pixels of the display device with the first and second set of drive signals thereby to display an image corresponding to the image data on the display device.

2. A method according to claim 1, wherein the first set of drive signals is represented by a first matrix and the second set of drive signals is represented by a second matrix, and wherein the obtaining of the second set of drive signals from the compressed image data comprises multiplying the compressed image data by the transpose of the first matrix thereby to obtain the second matrix.

3. A method according to claim 2, wherein the first matrix is a discrete cosine transform (DCT) based row matrix.

4. A method according to claim 2, wherein the first matrix is a discrete wavelet transform (DWT) based row matrix.

5. A method according to claim 4, wherein the discrete wavelet transform (DWT) based row matrix has LeGall 5,3 wavelet coefficients and wherein the obtaining of the second set of drive signals from the compressed image data comprises multiplying the compressed image data by the inverse of the first matrix thereby to obtain an intermediate matrix and then normalising the intermediate matrix thereby to obtain the second matrix.

6. A method according to claim 1, wherein the compressed image data is obtained by at least a 2-D transform of raw image data, the second set of drive signals being obtained from the transformed raw image data without carrying out a full inverse transform of the transformed raw image data.

7. A method according to claim 1, wherein the display panel is a liquid crystal display panel, the first set of drive signals are row drive signals and the second set of drive signals are column drive signals.

8. Apparatus for driving a display device to display an image thereon in accordance with image data, the display device having a first set of electrodes and a second set of electrodes which are addressed with a first set of drive signals and a second set of drive signals respectively in order to drive pixels of the display device, the first set of drive signals being predefined, the image data being compressed, the apparatus comprising:
a drive signal calculating device constructed and arranged to obtain the second set of drive signals from the compressed image data; and,
an addressing device constructed and arranged to address the pixels of the display device with the first and second set of drive signals thereby to display an image corresponding to the image data on the display device.

9. Apparatus according to claim 8, wherein the first set of drive signals can be represented by a first matrix and the second set of drive signals can be represented by a second matrix, the drive signal calculating device being constructed and arranged to obtain the second set of drive signals from the compressed image data by multiplying the compressed image data by the transpose of the first matrix thereby to obtain the second matrix.

10. Apparatus according to claim 8, wherein the compressed image data is obtained by at least a 2-D transform of raw image data, and wherein the drive signal calculating device is constructed and arranged to obtain the second set of drive signals from the transformed raw image data without carrying out a full inverse transform of the transformed raw image data.

11. Apparatus according to claim 8, wherein the display panel is a liquid crystal display panel, the first set of drive signals are row drive signals and the second set of drive signals are column drive signals.

12. Apparatus according to claim 8, wherein the drive signal calculating device and the addressing device are constituted in a single integrated circuit.

13. The use of image compression matrices (of the type used in compression standards such as JPEG, JPEG2000, MPEG-1, MPEG-2 and MPEG-4) in the generation of addressing signals for addressing the pixels of a display device.
